(19) United States
(12) Patent Application Publication
(10) Pub. No.: US 2010/0163634 A1
(43) Pub. Date: Jul. 1, 2010

(54) SYSTEMS AND METHODS FOR MONITORING, CONTROLLING AND LIMITING USAGE OF UTILITIES

(76) Inventors: Michael J. Klein, Poulsbo, WA (US); Jerry E. Armstrong, Poulsbo, WA (US)

Correspondence Address: BLACK LOWE & GRAHAM, PLLC, 701 FIFTH AVENUE, SUITE 4800, SEATTLE, WA, 98104, US

(21) Appl. No.: 12/493,087

(22) Filed: Jun. 26, 2009

Related U.S. Application Data
(63) Continuation-in-part of application No. 11/419,159, filed on May 18, 2006, now abandoned.
(60) Provisional application No. 61/076,478, filed on Jun. 27, 2008.

(51) Int. Cl. G05D 23/00

(52) U.S. Cl. 236/94

(57) ABSTRACT

Systems and methods for monitoring, controlling and limiting utility usage for a plurality of units in a building. An example system includes a controller and one or more sensing devices in signal communication with the controller using a buildings existing thermostat wiring. The system senses the state of a thermostat, the air temperature near each thermostat and the pipe/ducting temperature in each of a plurality of units. The pipe/ducting sensor monitors the temperature of piping or ducting leading from a thermostatically controlled supply valve to the unit requesting heating or cooling. Being able to use existing building thermostat wiring allows for installation into older buildings. The controller records utility usage information for each of the plurality of units based on information received from the one or more sensing devices and communicates with a website.

### PRIORITY CLAIM

This application is a Continuation-in-Part of U.S. application Ser. No. 11/419,159 filed May 18, 2006. This application claims the benefit of U.S. Provisional application Ser. No. 61/076,478 filed Jun. 27, 2008. Applicant hereby incorporates these applications by reference.

### FIELD OF THE INVENTION

This invention relates generally to utility monitoring and control systems and, more specifically, to remotely accessible, centralized utility usage monitoring and control systems for a plurality of units in a building, which can be used to determine an accurate pro-rata cost for individual users of the utility.

### BACKGROUND OF THE INVENTION

Many multi-family properties have a common boiler, chiller or furnace supplying heating or cooling via individual zone valves or ducting dampers controlled by a thermostat in each space “apartment or commercial”. It is generally understood that a central boiler heat pump or furnace system is more energy efficient than using separate heaters in each space. This higher efficiency is good for the environment as well lowering the energy demands of the nation. Also, it is generally understood that the maintenance costs are less for a central heating or cooling system than for individual systems.

However, landlords are responsible for the utility costs of centralized heating and cooling. There is currently no method of accountability for energy consumption to individual tenants when using these centralized systems. The tenants have very little incentive to lower their thermostat settings at night or when not at home. It is a common complaint among landlords that when some tenants are gone for the day they leave windows open in cold weather with the thermostat on. Without a precise record and system of accountability the landlord cannot determine who used the utility, much less charge anyone for consumption. Currently the landlord's only recourse is to charge all tenants a higher base rent.

There are several companies that market peripheral systems that can be added to personal computers to automate nearly anything from a home to a small factory, but they are quite expensive and come with software that provides little more than isolated output data from individual sensors. The software to provide an integrated solution to pro-rating the cost of utilities in a building with a plurality of units would have to be developed by the end user of these systems because the included software is not suited to the purpose.

Accordingly, there is a need for an easy to install monitoring and control system, that allows a user to determine the pro-rata share of the heating cost, and control temperature settings remotely for each of the units in a building with a centralized utility system. There is an additional need for the integrated system to provide features that allow a user to verify that the utility has been properly delivered to the units in accordance with their calculated pro-rata share as an audit measure. There is an additional need for the integrated system to provide meaningful system status messages to the user.

### SUMMARY OF THE INVENTION

The present invention provides systems and methods for monitoring, controlling and limiting utility usage for a plurality of units in a building. The system includes a controller and one or more sensing devices in signal communication with the controller using a buildings existing thermostat wiring. The system senses the state of a thermostat, the air temperature near each thermostat and the pipe/ducting temperature in each of a plurality of units. The pipe/ducting sensor monitors the temperature of piping or ducting leading from a thermostatically controlled supply valve to the unit requesting heating or cooling. Thereby verifying that the utility is being delivered as requested. Being able to use existing building thermostat wiring is a feature that allows for easier installation. The controller records utility usage information for each of the plurality of units based on information received from the one or more sensing devices and communicates with a user interface/web site.

The present invention is fair to every tenant. It empowers the owners to maintain a tightly running boiler system, which ensures that tenants are not paying for heat they did not order. This system aligns energy conservation to the user.

The present invention allows an owner to identify inefficiencies, identify wasteful tenants, take control of temperatures settings, and bill the individual tenants accurately and fairly for what they have actually consumed.

The property owner or manager can use the software tool to help determine how much of a credit to give each tenant. The intention here is to initially pass some responsibility for the gas bill to the tenants. If they have to pay for their consumption beyond the credit amount they will be careful.

Once the system is installed problems like zone valves stuck open delivering non-requested heat can be resolved. Then the max and min temperature settings for all spaces can be implemented. Many spaces have been found to be heating to almost 80 degrees. Based on this it is possible to see a 50% reduction in gas consumption as shown in the above columns before billing any tenants.

### BRIEF DESCRIPTION OF THE DRAWINGS

Preferred and alternative embodiments of the present invention are described in detail below with reference to the following drawings.

FIG. 1 is a diagram showing an embodiment of the present invention;

FIG. 2 is a diagram showing additional detail for the thermostat sender shown in FIG. 1 in accordance with an embodiment of the invention;

FIG. 3 is a diagram showing additional detail for an example embodiment of the controller, zone board selector and signal de-multiplexing device

FIG. 4 is a diagram showing additional detail for an example embodiment of the thermostat state selector shown in FIG. 3;

FIG. 5 is a diagram showing additional detail for an example embodiment of the pipe temperature selector shown in FIG. 3;

FIG. 6 is a diagram showing additional detail for an example embodiment of the thermostat sender selector shown in FIG. 3;

FIG. 7 is a diagram showing additional detail for an example embodiment of the 32 KHZ band pass filter & detector shown in FIG. 3;

FIG. 8 is a diagram showing additional detail for an example embodiment of the zone board shown in FIG. 1;

FIG. 9 is a diagram showing additional detail for an example embodiment of the permission to heat/cool registers shown in FIG. 3;

FIG. 10 is a diagram showing additional detail for an example embodiment of the simplified view of the relationship between the thermostat sender and the zone board;

FIG. 11 is a diagram showing additional detail for an example embodiment of the simplified view of the Fault logic triangle;

FIG. 12-1 thru 12-2 are flowcharts showing example processes performed by the systems described above;

FIG. 13 is a diagram showing additional detail for an example embodiment of the thermostat sender-timing diagram;

FIG. 14 is a diagram showing additional detail for an example embodiment of the flow meter circuit; and

FIGS. 15-43 are screenshots of an example user interface formed in accordance with an embodiment of the present invention.

### DETAILED DESCRIPTION OF THE PREFERRED EMBODIMENTS

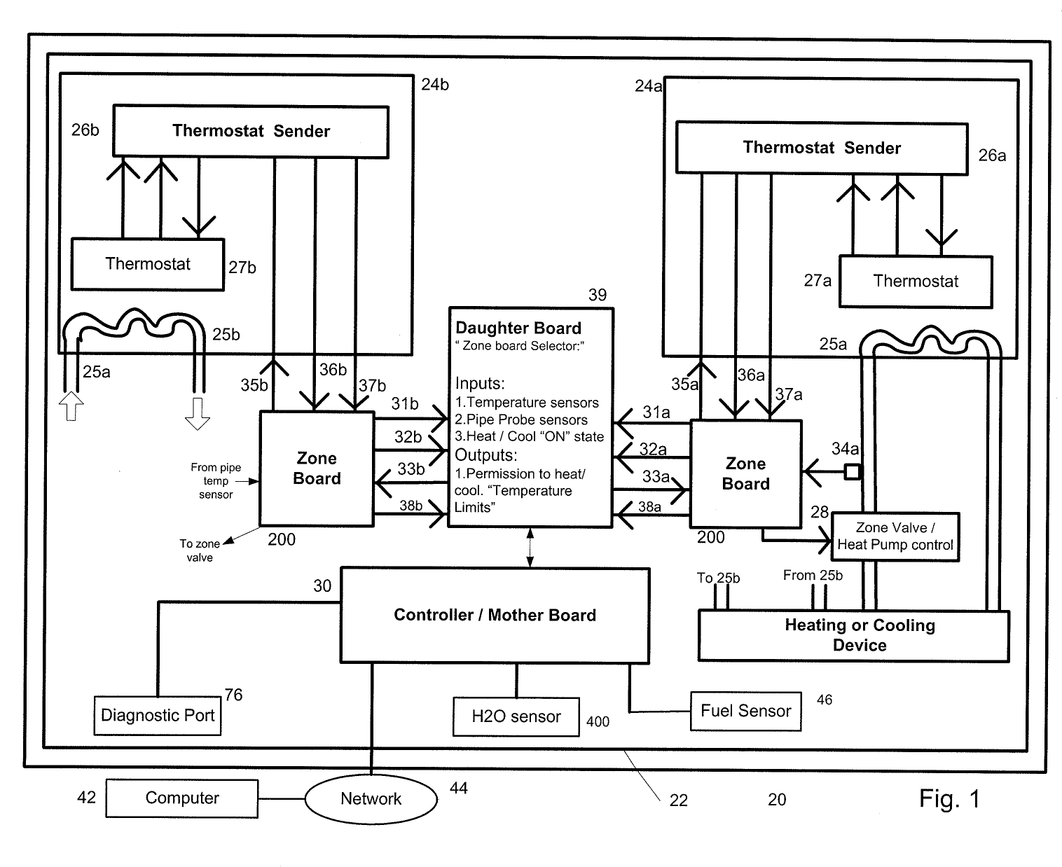

FIG. 1 is a diagram showing an embodiment of the present invention. A system 22 for monitoring and recording utility usage information in a building 20 having a plurality of spaces 24a, b to be monitored and controlled includes on-site components located within the building 20 and off-site components located external to the building 20. In an alternative embodiment, the spaces 24a, b are located in a plurality of buildings such that monitoring, controlling and recording occurs for spaces in a building complex rather than in a single building. Each of the spaces 24a, b includes a thermostat sender 26a, b for monitoring air temperature in the space 24a, b and a thermostat 27a, b. In one embodiment, the thermostat senders 26a, b monitor air temperature near the thermostats 27a, b. The spaces 24a, b may be apartments, individual rooms, common areas, units or other spaces using a centrally supplied utility. The spaces 24a, b also may be zones of multiple areas of the building 20.

In this embodiment, a heating device and a controller 30 distribute heat to radiators 25a, b located in the spaces 24a, b. The thermostats 27a, b are connected by wires to the thermostat sender 26a, b. The thermostat senders 26a, b are connected by wires 35a, b, 36a, b, 37a, b to a zone board 200 which sends and receives signals from the daughter board (a zone board selector 39), and controls a zone valve 28. When the thermostat 27a, b requests heat, the thermostat sender 26a, b causes a 15 VDC current to flow to the zone board 200 via wires 37a, b. Serial data representing the temperature in the spaces 24a, b is present on the wires 36a, b. The voltage level and frequency may be different in other embodiments. The zone board 200 acts as a remote control switch that in turn applies 24 VAC to actuate one or more of the valves 28. The actuated valve 28 then allows heated/cooled water, steam or air to pass from the utility to the space 24a, b. Heating/cooling distribution devices other than radiators may be used in other embodiments as well.

Temperature sensors 34a are located on heating or cooling pipes, air ducting and/or ducting dampers (not shown). The sensors 34a are used to verify that a heat or cool action is being delivered to the radiators 25a, b as requested by the thermostats 27a, b. The temperature sensor 34a has an operating range that corresponds to the type of system being used. For example, a system using steam may require the temperature sensors 34a with higher operating ranges than a system using hot water. Additionally, if a different type of utility is supplied in other embodiments, sensors other than temperature sensors such as an optical sensor are employed to verify proper delivery of the utility.

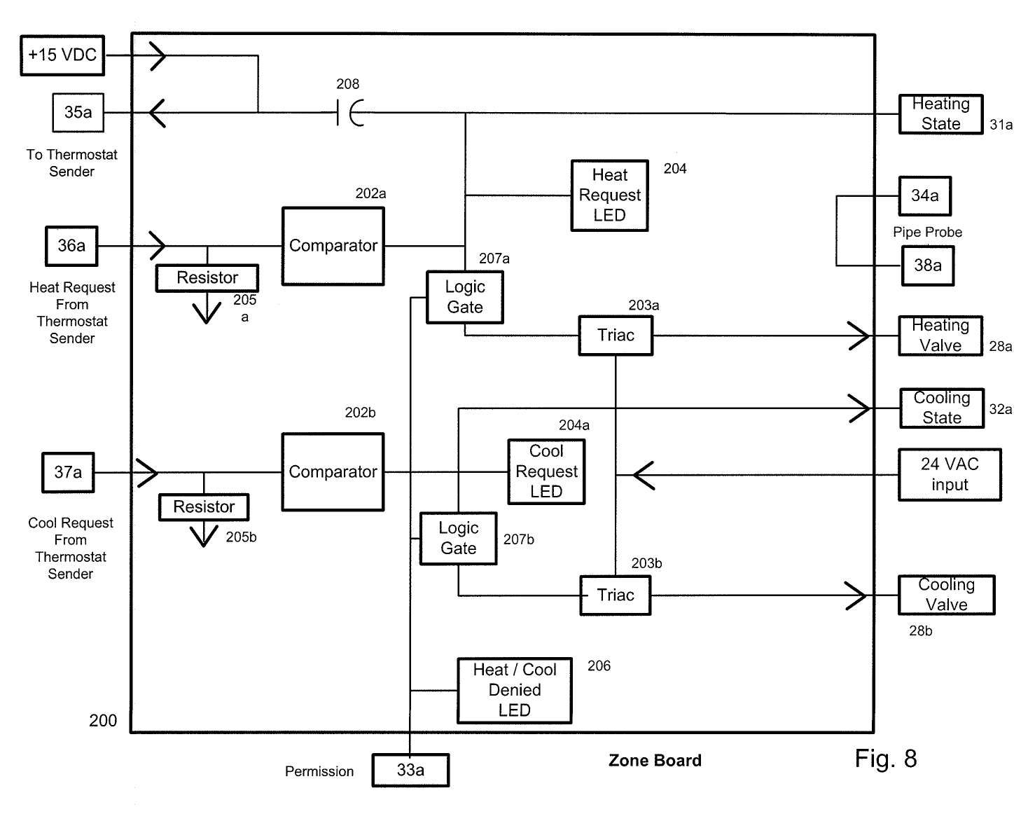

The controller 30 and the zone board selector 39 are in signal communication with the zone board 200 FIG. 8. In one embodiment the controller 30, the zone board selector 39 and the zone board 200 fit in a standard National Electrical Manufacturers Association (NEmA) industrial enclosure where it can be protected. The thermostats 27a, b are monitored by the controller 30 and the zone board selector 39. The thermostats 27a, b act as binary devices (ON or OFF). In this embodiment, the zone board 200 is directly wired to the pipe temperature sensor 34a and the thermostat senders 26a, b. In other embodiments the components communicate at least partially using wireless communication.

The off-site components include a computer 42 that is in data communication with the controller 30, via a network 44. A website provides a user interface that is presented to users of the computer 42. In one embodiment, the website is hosted by a third party server coupled to the network 44. In some embodiments, the network 44 is a telephone network and the computer 42 communicates with the controller 30, using a modem. In other embodiments, the network 44 is a public or private data network such as the Internet and the computer 42 communicates with the controller 30 using a network interface and website. In other embodiments, the network 44 is a wired and/or wireless network such as the Internet or an IEEE 802.11 a, b, g, or n network, for example. In still other embodiments, the computer 42 may connect directly to the controller 66. The controller 30 generates emergency text messages to a user via cell phone. The computer 42 is a standard general-purpose personal computer in one embodiment that includes a controller, memory, secondary storage, and communications means, keyboard, mouse, and display device. In other embodiments, a personal data assistant (PDA) could be used.

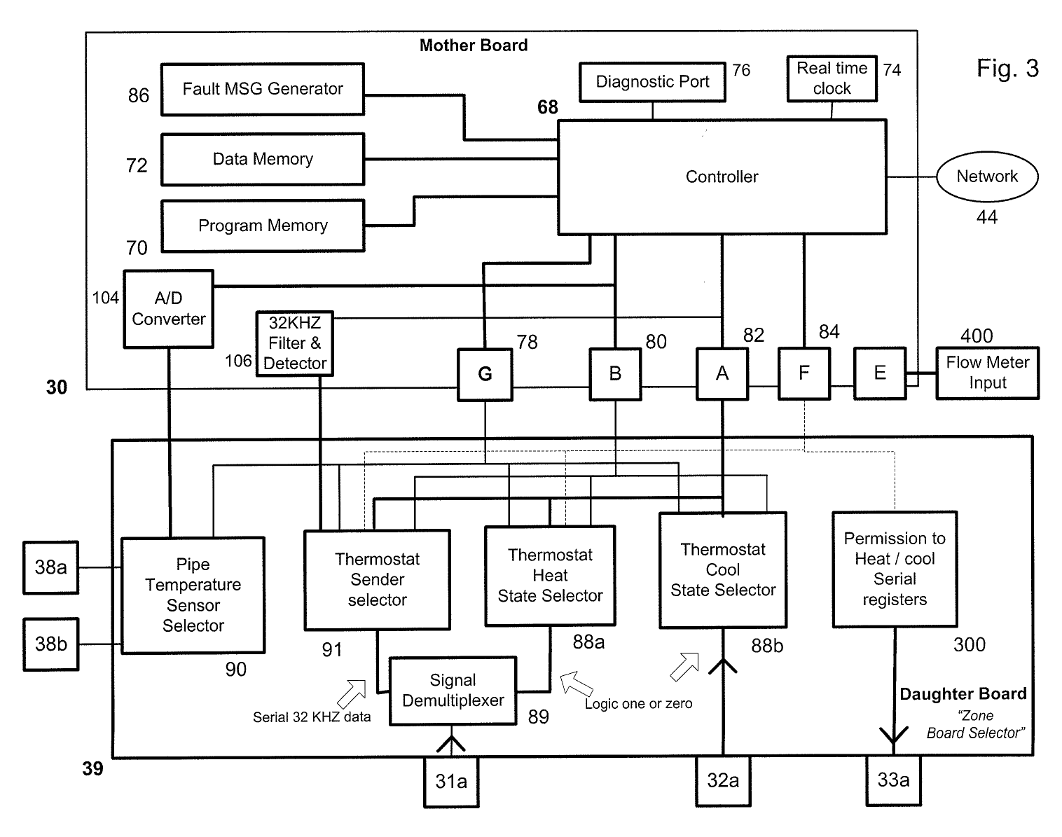

The computer 42 is used to access the hourly utility usage records via one or more of the communications methods mentioned above. The hourly records are processed by a controller 68 (FIG. 3) to determine the total number of “heating seconds” per hour received by each space 24a, b. The user interface/website presents totals of the hourly records and presents calculations of the fractional share of the total building's monthly heating bill for each space 24a, b. In this embodiment, remote access by the computer 42 to the website is password protected. The website may be accessed by other Internet capable devices such as a smart phone or PDA. The data output may be encoded to provide security for the overall operation of the system. However, these protections may not be in place in other embodiments.

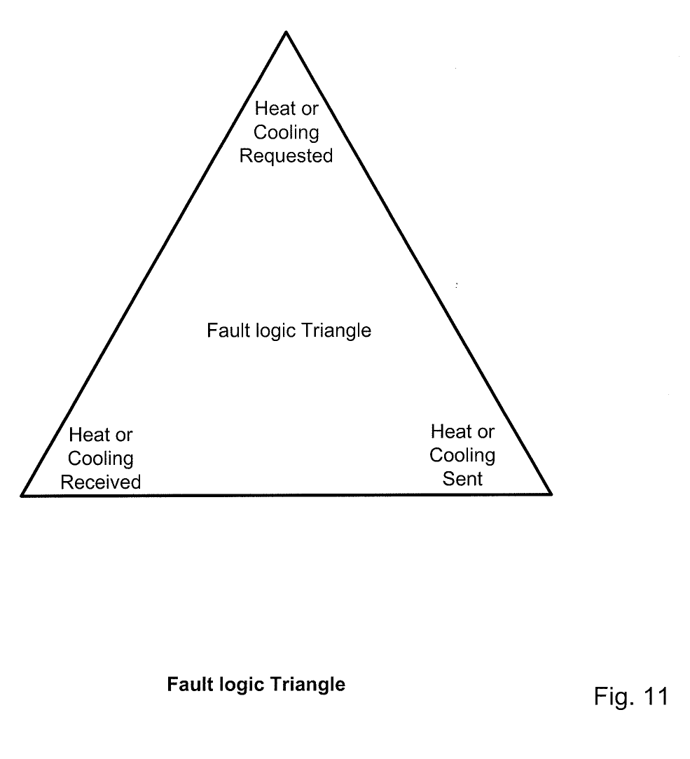

In one embodiment, a property manager for the building 20 accesses the user interface/website to generate heat consumption statements for each space 24a, b for every hour of every day. This allows the property manager to bill the tenants for what they have actually used. An hourly time stamped data record is generated. In one embodiment, a fault logic triangle (FIG. 11), which is the basis of the audit trail, includes of the following three recorded measurements:

First: The utility ON time;

Second: The hourly high and low pipe temperatures from the sensors 34a; and

Third: The hourly high and low temperature from the thermostat senders 26a, b.

In this manor, one is able to confirm that each space 24a, b has requested and received the utility for which they are being charged. Any fault conditions detected during normal operation of the system are Emailed or text messaged to the user or recorded.

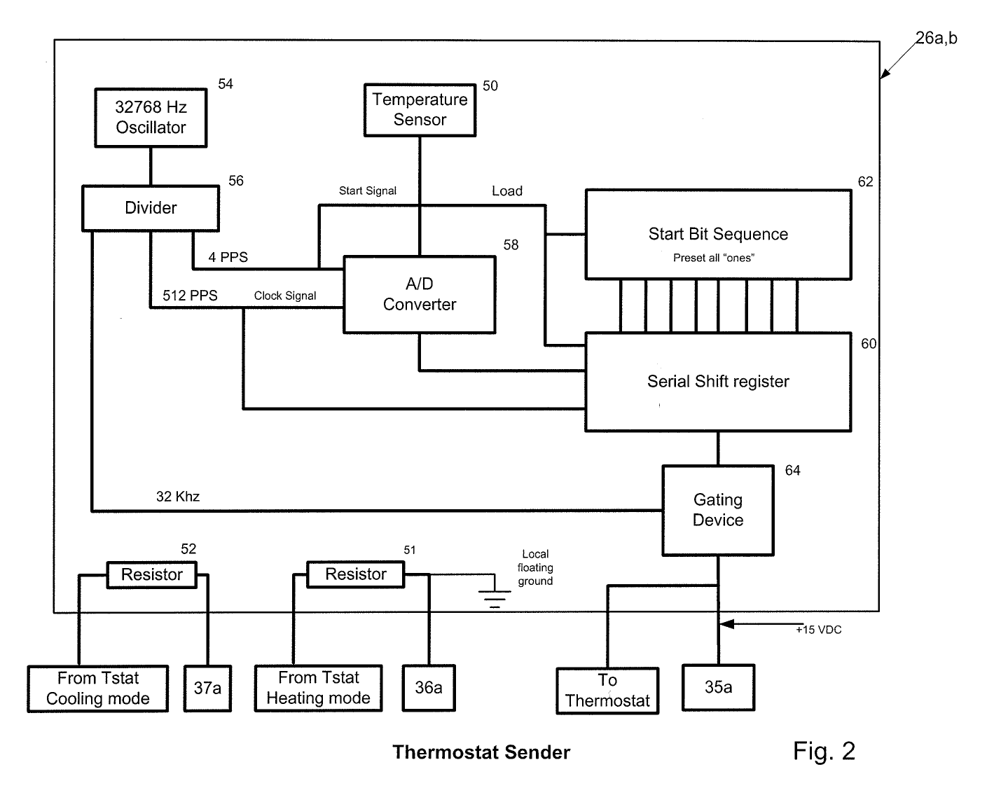

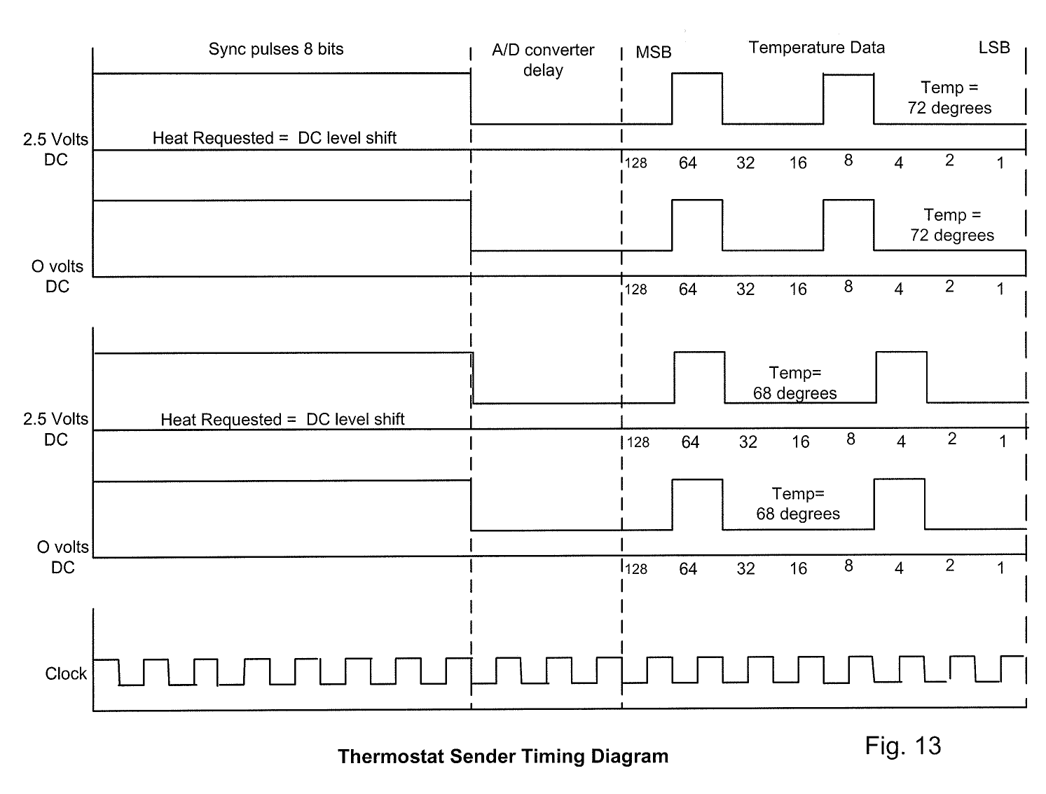

FIG. 2 is a diagram showing additional detail for the thermostat sender 26a. The thermostat sender 26a includes a temperature sensor 50 that produces an analog signal proportional to the temperature being sensed. This analog signal is converted to a digital value by a serial output analog to digital (A/D) converter 58. A 32 KHz crystal 54 controls a 14-stage binary divider 56. Pin 1 of the divider 56 provides 4 start pulses per second (pps). Pin 2 provides a 512 pps clock signal. Pin 3 provides an oscillator output of 32 KHz. The start pulse triggers the A/D converter 58 to start a conversion of the analog signal from the temperature sensor 50 and loads a start bit sequence from a bit loader 62 into a parallel load shift register 60 at the same time. See the 8 bit sync pulse pattern on timing diagram (FIG. 13). The A/D converter 58 and the shift register 60 are clocked together by the 512 pps clock signal. As the shift register 60 is clocked, the pre loaded bits are shifted out at one end and the data bits from the A/D converter 58 are shifted in at the other end. While this shifting process is going on, the shift register 60 output controls the gating of the 32 KHz signal from the divider 56 onto the thermostat wire 35a at a gating device 64. The gating device 64 places a 32 KHz tone on the thermostat wire 35a if a binary “1” is present and “no tone if a binary “0” is present. The resulting tone burst pattern represents the temperature measured by the A/D converter.

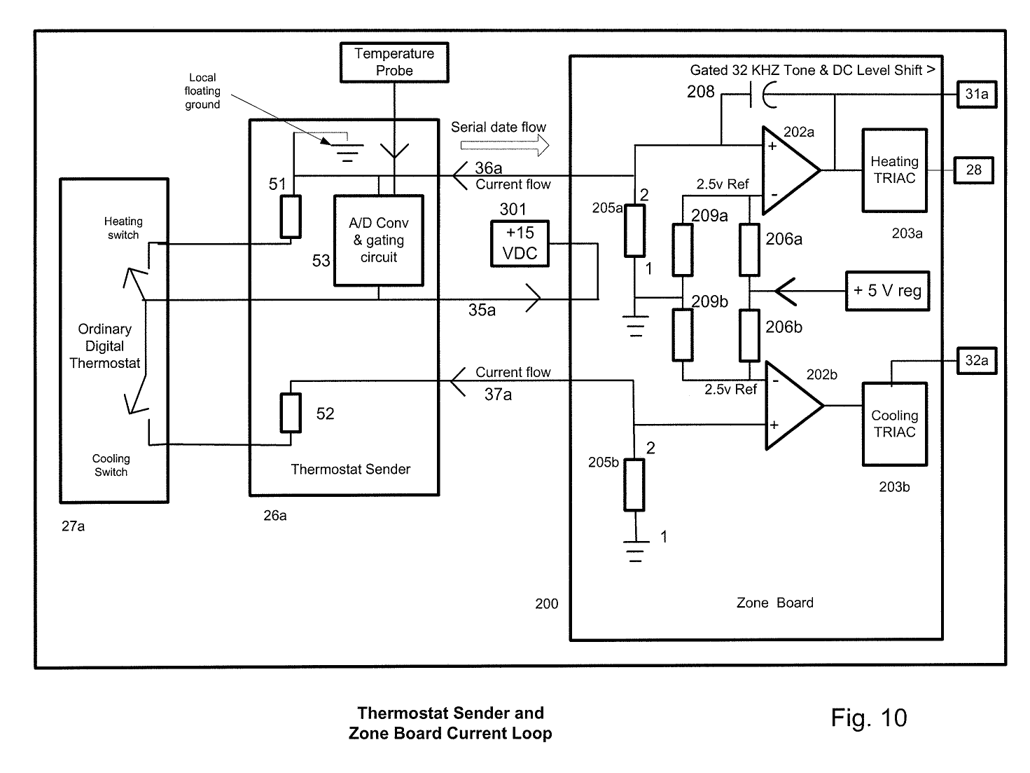

Conventional 2 wire thermostats use 24 VAC and act as a simple switch which supplies a large current typically (330 mA) to operate a valve. In the system 22 the 24 VAC is disconnected from the thermostat wires and the thermostat sender 26a is supplied with +15 VDC instead. This allows the thermostat sender 26a to continue to operate continuously using the existing thermostat wires regardless of weather or not the thermostat is on or off, requesting heating or cooling. In this embodiment only 20 mA of current is needed, thus making this system safer by a factor of 15:1 over conventional 24VAC systems. The +15VDC forms a current loop with 32 KHZ serial data multiplexed on to a single pair of wires. In FIG. 10 the system 22 uses 120 VAC from a common wall outlet to power a +15 VDC supply 301. The positive output is connected by wire to the zone board 200, where its positive voltage is connected by the wire 35a to the thermostat sender 26a. The negative side of the 15 volt supply 301 is connected to a resistor 205a pin 1 on the zone board 200. Pin 2 of the resistor 205a is connected by the wire 36a to the thermostat sender 26a. The effective resistance of an A/D converter and gating circuit 53 is in series with the resistor 205a thereby forming a voltage divider which causes a voltage drop across the resistor 205a pin 1 which is sensed by a “heating” comparator 202a at its non-inverting input. When the thermostat 27a requests heat, by closing its switch, a resistor 51 is added in parallel with the effective resistance of the A/D converter and gating circuit 53 thereby causing the current flowing through the resistor 205a to double. When the current through the resistor 205a doubles the voltage drop across it also doubles. This increase voltage is presented to the non-inverting input side of the comparator 202a causing its output to swing to the +5 volt rail. This 5 volt output causes a triac 203a to turn on thereby applying 24 VAC to the zone valve 28. The 32 KHZ tone burst pattern “serial data” is passed through a capacitor 208 and is thereby riding on top of a DC shifted level. This 5-volt level represents the heat request “ON” state and the zero volt level represents the heat “OFF” state. The serial temperature data is always present however. This method allows the thermostat sender 26a to send serial data representing the temperature along with the request for heat using only two wires available in many older buildings. A third wire 37a may be available in buildings that also provide cooling such as when a heat pump is used. The current loop in this case is through a resistor 52 and a resistor 205b and causes a cooling comparator 202b to operate in the same manner as the heating comparator 202a.

FIG. 3 is a diagram showing additional detail for an example embodiment of the zone board selector 39 and the controller 30 also shown in FIG. 1. The zone board selector 39 includes thermostat state selectors 88a, 88b, a signal de-multiplexer 89, and a pipe temperature selector 90.

The controller 30 includes a program memory unit 70, a data memory unit 72, a plurality of input/output (I/O) ports 78-84, a fault message generator 86, a diagnostic port 76 and a networking port 44, in data communication with the controller 68. In other embodiments, there may be greater or lesser numbers of ports and the ports may be designated as input or output specific ports rather than I/O ports. For example, in one embodiment, a Rabbit 3000® microcontroller by Rabbit Semiconductor is used that includes seven I/O ports.

The thermostat senders 26a, b are in signal communication with the zone board 200 (FIG. 1) via the existing building 20 thermostat wires 36a, b, 37a, b. Each zone board 200 can actuate several electrically operated valves and passes three signals to the zone board selector 39. There is a plurality of zone boards, one for each valve, water heater, gas dryer, or other device, and each is wired to a unique data channel at the zone board selector 39.

The zone board (FIG. 8) passes four signals to the zone board selector 39:

One: 32 KHZ serial temperature data;

Two: thermostat heating state;

Three: thermostat cooling state; and

Four: pipe temperature.

“One” and “Two” are multiplexed on the wire 31a to the signal de-multiplexer 89, where the 32 KHZ tone burst data is separated from the DC level representing the heating state. The 32 KHZ tone burst data signal is presented to a thermostat sender selector 91 which routes the data to a 32 KHZ filter detector 106. The DC level representing the heating ON state is passed to the thermostat heat state selector 88a. The cooling state is sent by wire 32a to the thermostat cooling state selector 88b. The pipe temperature is sent by wires 38a and 38b to the pipe temperature selector 90 which sends the signal to a A/D converter 104. The result is serially shifted into port B 80 by the controller 68. The controller 68 is in signal communication with the pipe temperature sensor selector 90 using port G 78.

The controller 68 is in data communication with the thermostat sender selectors 88a, 88b using ports B 80, A 82, F 84. The controller 68 selects thermostat states from particular spaces 24a, b using the thermostat sender selectors 88a, 88b. However, in other embodiments the signal communications are transmitted using wireless radio frequency (RF) communications or other means.

A clock 74 (crystal) drives a real-time clock function in the controller 68. The clock 74 provides the year, month, day and time of day in hours, minutes and seconds when requested by a software program run by the controller 68 by using a library function supplied by the manufacturer of the controller 68. In one embodiment, the clock 74 is synchronized to the nuclear clock in Denver Co. This time value is used to time stamp the collected data by recording in the data memory 72 the time value when saving the pipe temperatures, thermostat temperatures, and thermostat states. Other approaches to generating a real-time clock could be used in other embodiments as there are several ICs that provide an external real-time clock that can be read by a controller.

The controller 68 stores the selected inputs from the temperature sensors 34a, thermostat senders 26a, b, and the thermostat states 27a, b in the data memory unit 72. In some embodiments the controller 68 accumulates the stored thermostat state values each hour to determine the number of seconds in that hour that the thermostat state was set to “ON”. This “ON” seconds per hour value is then stored in the memory unit 72. A time stamp is also stored along with the number of “ON” seconds so a user will know the time period for which the “ON” seconds value is valid. In some embodiments, the controller 68 also stores the hourly maximum and minimum temperature values for the pipe temperatures 34a and the thermostat senders 26a, b. If a newly measured value is above the previous maximum temperature value or below the previous minimum temperature value for that hour, the hourly record is updated with these new values. Once per hour, the controller 30, accumulates the total seconds of thermostat “ON” states, hourly high and low temperatures, and records an hourly utility usage record for each of a plurality of spaces 24a, b.

The computer 42 can also be used to remotely configure the controller 30 via the network 44 and a user interface such as a website. Remote configuration is accomplished by sending at least one of a plurality of constant values from the computer 42 to the controller 68 via the user interface, using any of a number of different devices and/or communication protocols. Some of the parameters that can be configured remotely include: a system serial number for unique system identification, number of thermostats, boilers, water heaters, gas dryers, water meters, fuel meters, a phone number to call if the system detects a fault, a system password, and individual temperature limits for all spaces. Additionally, the date and time are verified, the clock can be corrected remotely, collected data can be downloaded to verify correct operation of the system at any time, and old data can be erased from data memory unit 72 or other memory, if desired. Example user interfaces are shown in the example screenshots.

FIG. 11 shows a fault logic triangle, which is used to generate alarm messages. The top leg of the triangle represents “heating or cooling requested”. The bottom right hand leg represents “heating or cooling sent”. The bottom left leg represents “heating or cooling received”. By analyzing the different types of data at each of the 3 legs the following conclusions can be made:

1: If heating or cooling has been requested but not received a valve may be stuck closed;

2: If heating or cooling was sent but not requested a valve is stuck open;

3: If heat is requested and sent but the unit temperature remains too low a window may be left open;

4: If the unit temperature falls below the safe threshold of 50 degrees the unit is in danger of freezing and an emergency text message is sent;

5: If a unit fails to send temperature data there may be tampering; and

6: If a unit has a sudden drop of 10 to 15 degrees within an hour accompanied with a constant demand for heat there may be tampering such as a tenant placing something cold on the thermostat in an attempt to override the system temperature limits.

FIGS. 12-1 and 12-2 are flowcharts of example processes performed by the system 22 shown in FIG. 1. The process generates the following alarm fault flags.

Triggering events are grouped broadly into type 1-3 faults. Type 1 faults are “supply faults” and occur when a resource is requested but not delivered, such as might be caused by a valve being stuck in an “OFF” position, or when a resource is provided that was not requested, such as might be caused by a valve being stuck in an “ON” position. Type 2 faults are “limit violations” and occur, for example, if an extremely hot or cold temperature is detected. In embodiments where other types of sensors are used such as humidity sensors, water meters, fuel meters, or particular types of gas sensors, a limit violation may also be a humidity level exceeding a specified threshold value or a detected explosive or toxic gas concentration. In the present embodiment, the following conditions are tested for and used to set alarm flags in memory. Type 3 faults occur when there is evidence of “possible tampering”.

If a space 24a, b is requesting heat for at least 3000 seconds and the pipe temperature never gets above the heat threshold values set at the website and the pipe temperature change “delta” is less than 10 degrees the “valve stuck closed” alarm flag is set. If a space 24a, b is requesting cooling for at least 3000 seconds and the pipe temperature never gets below the cooling threshold values set at the website and the pipe temperature change “delta” is less than 10 degrees the “valve stuck closed” alarm flag is set. If the space 24a, b has zero seconds of heat requested during an hour, the pipe temperature is above the minimum threshold value set by the website and the pipe temperature “delta” is greater than 35 degrees the “valve stuck open” alarm flag is set. If the space 24a, b has zero seconds of cooling requested during an hour, the pipe temperature is below the maximum threshold value set by the website and the pipe temperature “delta” is greater than 35 degrees the “valve stuck open” alarm flag is set. If a space 24a, b is requesting heat for at least 3500 seconds, the pipe temperature is above the minimum threshold value set by the website and the pipe temperature “delta” is greater than 35 degrees and the space 24a, b temperature is below 65 degrees the “open window” alarm flag is set. If a space 24a, b is requesting cooling for at least 3500 seconds, the pipe temperature is above the is below the maximum threshold value set by the website and the pipe temperature “delta” is greater than 35 degrees and the space 24a, b temperature is above 75 degrees the “open window” alarm flag is set. If a space 24a, b temperature ever drops below the minimum safe temperature threshold established by the website, the alarm flag “space in danger of freezing” is set and an immediate interrupt occurs causing the controller 68 to call home to the web site which causes a text message to be sent to the user. If a space 24a, b has a drop of more than 10 degrees during an hour, the pipe temperature is above the minimum threshold set by the website, the pipe temperature “delta” is less than 10 degrees for the hour, and the space 24a, b warms up slowly over the next several hours the “tampering” alarm flag is set. If a space 24a, b temperature is ever zero degrees a “thermostat sender failure” alarm flag is set. This condition could be due to a component failure or tampering.

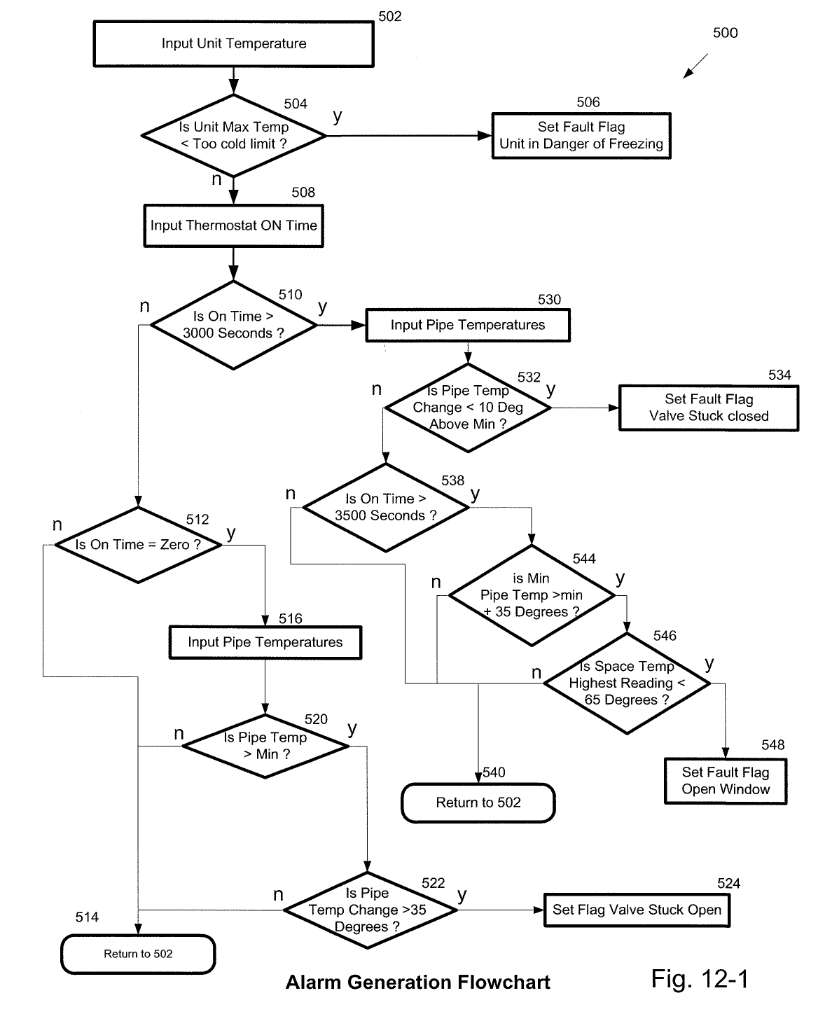

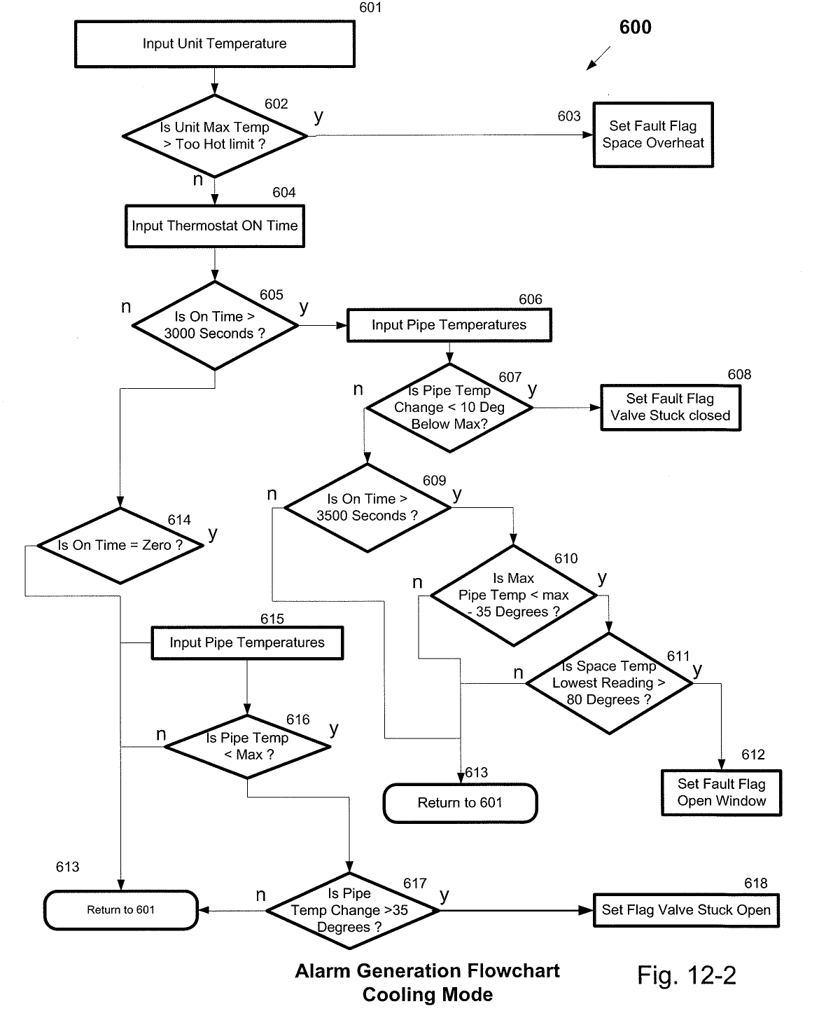

FIG. 12-1 is a flowchart of an example process 500 that demonstrates how the alarms are generated during a heating mode. At a block 502, hourly recorded high and low temperatures from a space selected from a plurality of spaces is read (input) from an array (storage). Then, at a decision block 504, the inputted temperature is tested against a “too cold limit” which is a previously stored value. If the space temperature is determined to be below the too cold limit, the space is in danger of freezing and alarm flag is set, see block 506. If the temperature is determined to not be below the too cold limit, then, at a block 508, thermostat on time is retrieved from an array (storage). At a decision block 510, the thermostat on time value is tested to see if it's greater or less than a predefined time limit (e.g., 3000 seconds). If the on time is determined to be less than the time limit, then, at a decision block 512, the thermostat on time value is checked to see if it is equal to zero. If the thermostat on time value is not equal to zero, then, at a block 514, the process returns control back to block 502. If the on time is determined to be equal to zero, then, at a block 516, hourly recorded high and low pipe temperatures are inputted from an array (storage). Next, at a decision block 520, the pipe temperatures are compared with a predefined minimum pipe temperature value. If the pipe temperature is determined to be less than the minimum value, then the process goes to block 514. If the pipe temperature is determined to be greater than the minimum value, then, at a decision block 522, the pipe temperature is checked to see if it is more than a predefined amount (e.g., 35 degrees) above the minimum value. If the pipe temperature is determined to be more than the predefined amount above the minimum value, then, at a block 524, the alarm flag is set for valve stuck open. This indicates that un-requested heat is being delivered. If the pipe temperature is determined to be less than the predefined amount above the minimum value, then the process returns to main, see block 514.

If at the decision block 508 the on time is greater than the predefined time limit, then the pipe temperatures for the hour are inputted at a block 530 and compared at a decision block 532 to determine if it is less than a predefined number of degrees (e.g., 10 degrees) above the minimum value (too cold limit), then, at a block 534, an alarm flag valve stuck closed is set indicating that heat was requested but not delivered.

If the pipe temperature is determined to be greater than predefined number of degrees above the minimum, then, at a decision block 538, the on time is checked to see if it is greater than a second predefined time limit (e.g., 3500 seconds). If the on time is not greater than the second predefined time limit, then the process returns to main, see block 540. If the on time is greater than the second predefined time limit, then, at a decision block 544, the pipe temperature is checked to see if it is at least a predefined amount of degrees (e.g., 35 degrees) above the minimum value. If the pipe temperature is determined not to be above the predefined amount of degrees above the minimum value, then the process returns to main, block 540. If the pipe temperature is determined to be above the predefined amount of degrees above the minimum value, then, a decision block 546, the highest recorded temperature for the hour in the space is checked to see if it is less than a predefined temperature value (e.g., 65 degrees). If the highest recorded temperature is not less than the predefined temperature value, then the process returns to main, block 540. If the highest recorded temperature is less than the predefined temperature value, then, at a block 548, an open window alarm flag is set.

FIG. 12-2 is a flowchart of an example process that demonstrates how cooling alarms are generated. The hourly high and low “pipe temperatures”, “space temperatures” and the accumulated “cooling request ON times” are stored in memory storage array of the processor 68. The maximum and minimum values are stored. The space temperature is read from the array at a block 601. At a decision block 602, the space temperature is tested to see if it is greater than a previously stored too hot limit value. If the space temperature is greater than the too hot limit value, then, at a block 603, a space over heat alarm flag is set.

At a block 604, cooling request ON time is read from the memory and at a decision block 605, the cooling request ON time is tested to see if it is greater than a predefined time limit (e.g., 3000 seconds). If the ON time is less than the predefined time limit, it is checked to see if it is equal to zero at a decision block 614. If the cooling request ON time is not equal to zero, the process returns to block 601.

If the ON time is equal to zero, the pipe temperatures are read at a block 615. At a decision block 616, the pipe temperature is checked to see if it is less than a previously stored maximum value. If it is not less than the maximum value, then the process returns to block 601. If however the pipe temperature is less than the maximum value, a pipe temperature change “delta” is tested at a decision block 617 to see if it is greater than a predefined value (e.g., 35 degrees). If the delta is not greater than the predefined value the process returns to block 601. If the delta is greater than the predefined value, the alarm flag valve stuck open is set at a block 618, thus indicating a valve stuck open condition.

If the ON time greater than the predefined time limit (decision block 605), the pipe temperature is read from memory at block 606 then it is tested at a decision block 607 to see if the temperature change “delta” is less than a second predefined value (e.g., 10 degrees) below the maximum temperature. If it is less than the maximum value, an alarm flag is set at a block 608, thereby indicating a valve stuck closed condition.

If the “delta” is not less than the max value, then the ON time is tested at a decision block 609 to see if it is greater than a second predefined time limit (e.g., 3500 seconds). If it is less than the second predefined time limit, the process returns to block 601.

If the ON time as determined at a decision block 609 is greater than second predefined time limit, then at a decision block 610 the pipe temperature is checked to see if the maximum cooling pipe temperature is less than the stored maximum value minus 35 degrees. If the maximum cooling pipe temperature is not less than the maximum value minus 35 degrees, the process returns to block 601. If the maximum cooling pipe temperature 610 is less than the maximum value minus 35 degrees, then the stored space temperature it is checked to see if the lowest reading is greater than 80 degrees at a decision block 611. If the maximum cooling pipe temperature is not greater than 80 degrees, then the process returns to block 601. If maximum cooling pipe temperature is greater than 80 degrees, an alarm flag 612 is set, thereby indicating an open window condition.

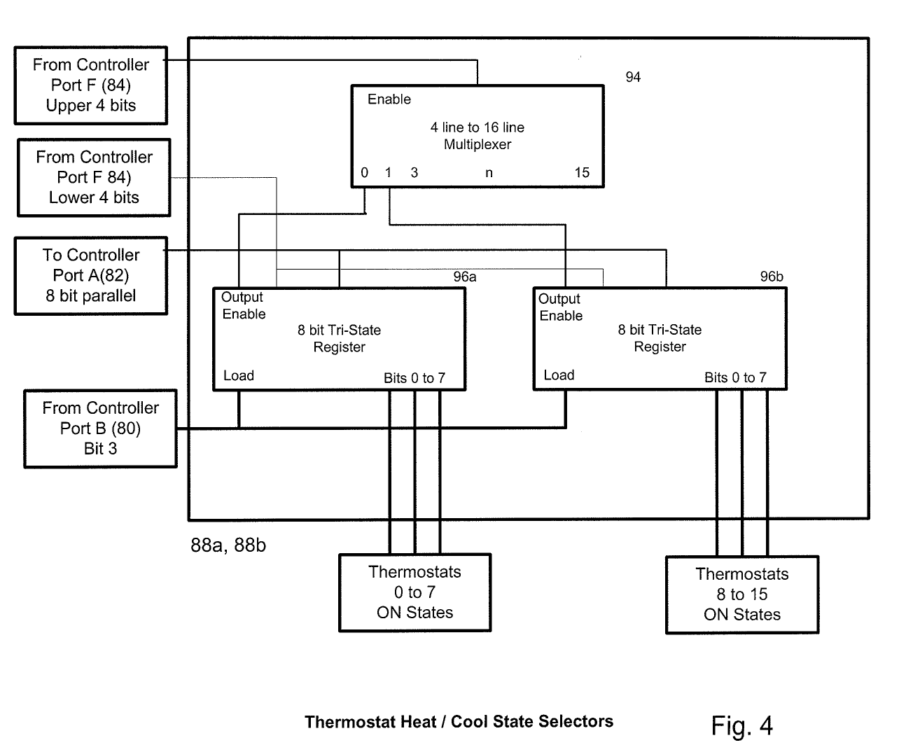

As shown in FIG. 4, each of the thermostat sender selectors 88a, b includes a thermostat state sensor multiplexer 94. In this embodiment, the thermostat state sensor multiplexer 94 is a four to sixteen line multiplexer. The four input bits of the thermostat state sensor multiplexer 94 are received from the lower four bits of the controller 68 Port F 84. The thermostat state sensor multiplexer 94 includes 16 outputs, each one of which is used to sequentially output enable a unique tri-state register. Not all of the tri-state registers are shown in the diagram for clarity, but a first tri-state register 96a, and a second tri-state register 96b are shown as examples. The number of tri-state registers 96a, b varies depending on the number of thermostat states that need to be sensed. For fewer spaces 24a, b, and thus fewer states, fewer tri-state registers 96a, b, are used. In addition to an output enable each tri-state register 96a, b has an eight bit parallel input. Each bit is connected to a unique zone board by wire 31a. Each bit of the eight bit input indicates a unique thermostat state of “ON” or “OFF” corresponding to the thermostats 27a, b in each of the plurality of spaces 24a, b. Each of the eight bit inputs will be a binary ‘0’ if the corresponding thermostat state is “OFF” and a binary ‘1’ if the corresponding thermostat state is “ON”. The first tri-state register 96a corresponds to thermostat states associated with a first 8 zones and the second tri-state register 96b corresponds to thermostat states associated with a second 8 zones. The eight inputs to the tri-state registers 96a, b are latched with a load enable signal from Port B 80 bit 3 from the controller 68. After the thermostat states have been loaded in to the tri-state registers 96a and 96b, the states are read one at a time into the controller 68 thru Port A 82.

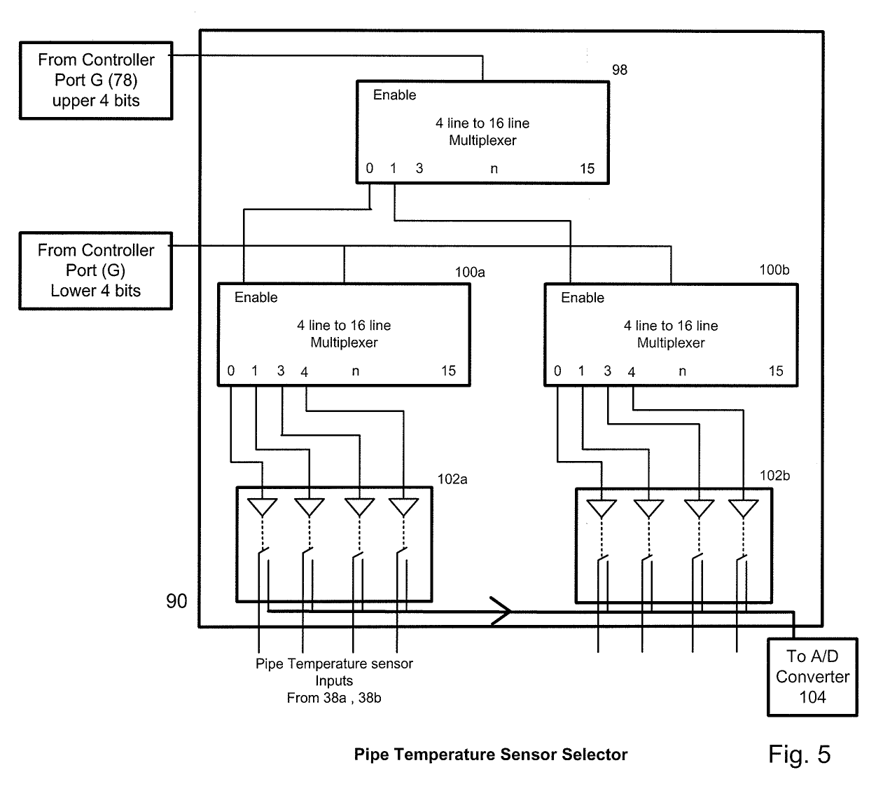

FIG. 5 is a diagram showing additional detail for an example embodiment of the pipe temperature selector 90 of the zone board selector 39. The pipe temperature selector 90 sequentially selects pipe temperature inputs under computer control. The pipe temperature selector 90 includes a 4 line by 16 line multiplexer 98. The four input bits of the multiplexer 98 are received from the upper four bits of the Port G 78 of the controller 68. Each of the sixteen output bits of the multiplexer 98 is used as an enable input to one of a series of four to sixteen line multiplexers 100a, 100b. Only two of which are shown for clarity. Fewer or greater numbers of multiplexers may be used in other embodiments. The four input bits for the pipe temperature data multiplexers 100a, b are received from the lower four bits of Port G 78 of the controller 68 on a common bus. Each pipe temperature data multiplexer 100a, b and has a sixteen bit output. Each of the sixteen bits sequentially selects a solid state relay 102a, b. Only the solid state relays 102a, b are shown for clarity. Each selected output is associated with a unique pipe temperature sensor input 34a and is sequentially routed to the A/D converter 104. In this embodiment, the serial output of the A/D converter 104 is received by bit 0 of Port B 80. Bits 6 and 7 from Port B 80 provide the start convert and clock signals to control the A/D converter 104.

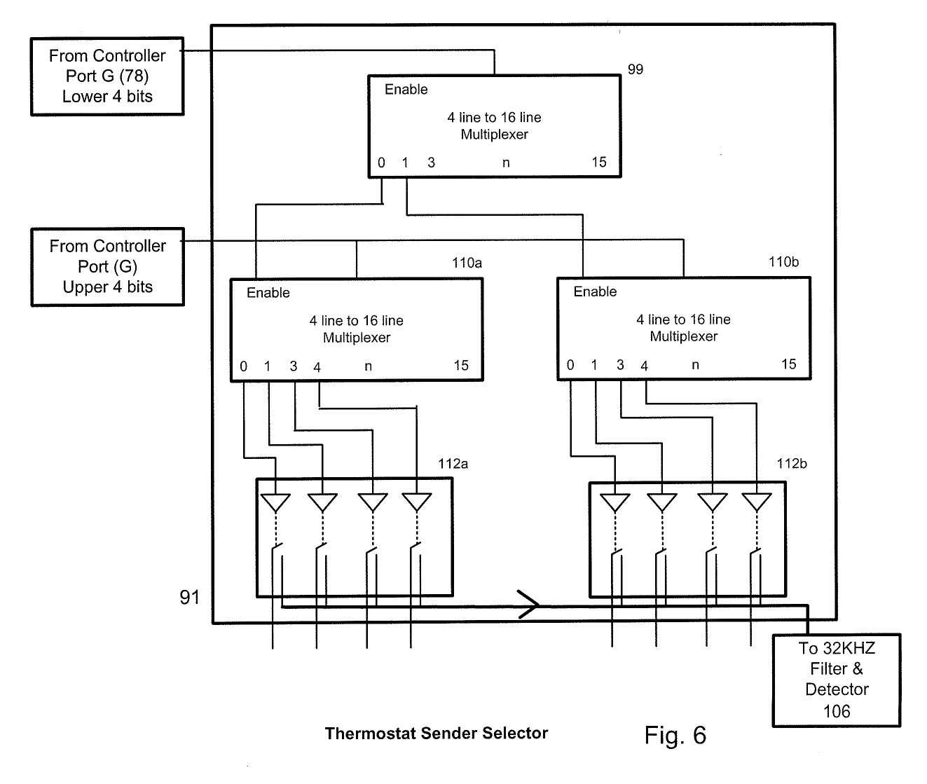

As shown in FIG. 6, the thermostat sender selector 91 includes a four to sixteen line multiplexer 99. The four input bits of the multiplexer selector 99 are received from the upper four bits of Port G 78 of the controller 68. Each of the sixteen output bits of the multiplexer selector 99 is used as an enable input to one of a series of 4 to sixteen line multiplexers 112a, and 112b. The lower 4 bits of Port G are used to sequentially select one of the 16 output bits of 110a, 110b. Each of the 16 output bits operates a unique solid state relay 112a, 112b. The thermostat sender selector 91 sequentially selects thermostat sender inputs under computer control.

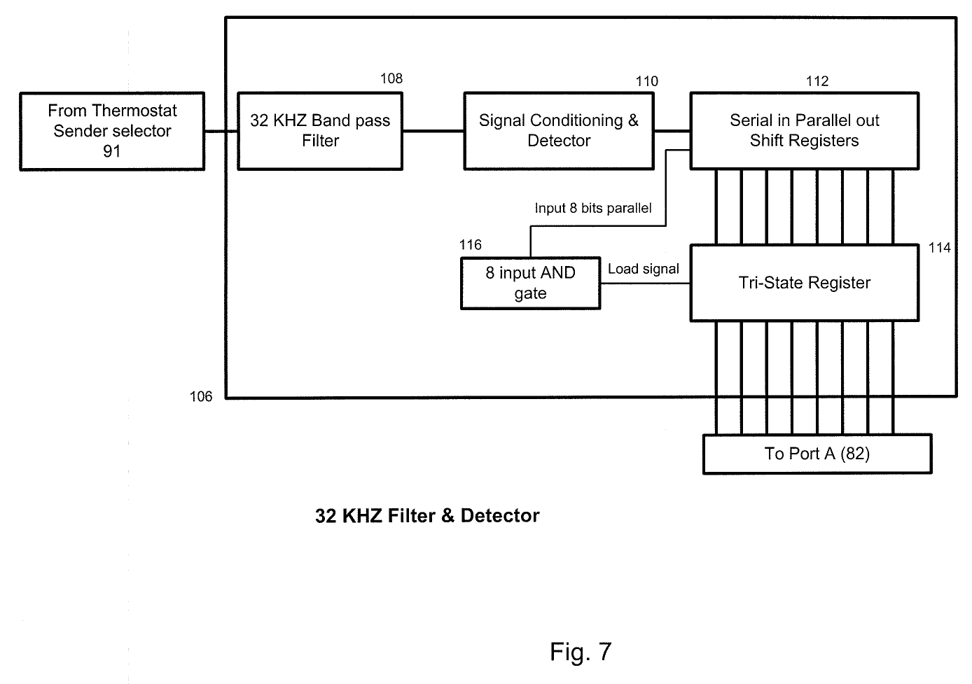

FIG. 7 is a diagram showing additional detail for an example embodiment of the filter detector 106 shown in FIG. 3. The detector 106 is an asynchronous data modem with a narrow band tuned filter network that amplifies the 32 KHZ signal and rejects out of band signals. Then it shapes the pulses into 5 volt logic levels and removes the 32 KHZ carrier frequency. The pulses are serially clocked through 5 sets of 8 bit serial registers. The start signal loads the data into the tri-state register 114. The filter detector 106 receives the output of the thermostat sender selector 91 as an input. In other embodiments, the filter detector 106 receives the output of additional thermostat sender selectors. The input to the filter detector 106 contains the serial tone sequence generated by one of the thermostat senders 26a, b that is sent from the thermostat sender selector 91. The input signal is passed through a filter 108 tuned to 32 KHz. A signal conditioning and detecting device 110 converts the detected signal into digitized data, which is passed to a serial in, parallel out shift register 112. The timing of the receiving shift register 112 is generated by using a 14 bit divider IC (not shown) with a 32 KHz crystal controlled oscillator (not shown). This provides the same shift clock frequency used by the thermostat senders 26a, b. The start bit sequence from the bit loader 62 of the thermostat sender 26a arrives via the thermostat sender selector 91. The start sequence arrives first and is followed by the A/D data bits. When the start bit sequence arrives at the far end of the shift register 112, it is detected with a multiple input AND gate 116, that loads the data bits into a tri-state register 114 where it is held until read by the controller 68 via Port A 82.

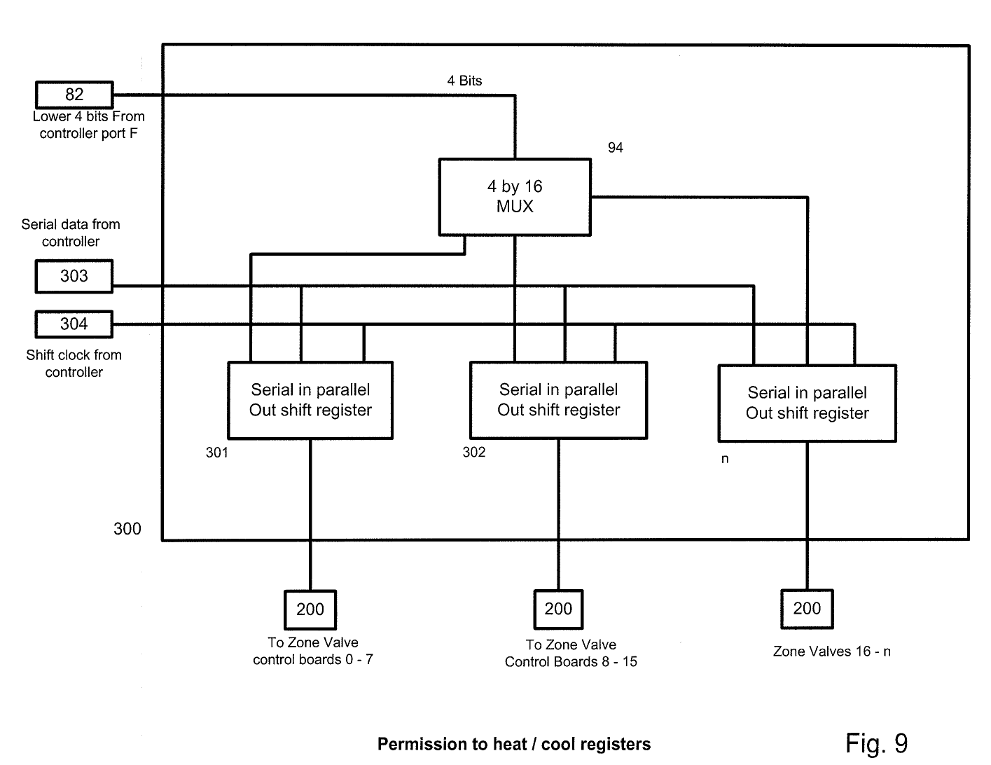

FIG. 9 is a diagram showing additional detail of a permission to heat/cool register 300 located in the zone board selector 39. The lower 4 bits of port F 84 are in signal communication with a 4 to 16 line multiplexer 94. The outputs of the multiplexer 94 sequentially selects one serial-in to parallel out register 301, 302 at a time. When the register 301 is enabled by the multiplexer 94, the controller 68 places data on a data line 303 then clocks it in one bit at a time via a clock 304. After eight clocks, a bit pattern is stored in the register 301. Each bit 0-7 is connected by wire 33a to a unique zone board 200 FIG. 8. A logic “One” is used to deny heat, a logic “Zero” allows heat. A manual reset button is provided to reset the registers in the event of a system failure.

The permission to heat or cool signal is presented to the zone board 200 and limits heat or cooling to a predefined value. As shown in FIG. 10, to deny heat a 5 volt DC level is presented via wire 31a to a gate device 209a, b which inhibits both triac's 203a, b from conducting 24 VAC to the zone valve 28. When permission to heat/cool is denied, a light emitting diode (LED) 206 is illuminated to provide visual diagnostics. By requiring a logic level “one” to deny heat, the system is protected against accidentally denying heat or cooling to a unit. This safety feature prevents a space from accidentally freezing in the event of signal loss.

There are many types of flow meters available. Some have rotating magnetic “vanes” that have different scaling factors such as one rotation per gallon, or 1 rotation per 10 gallons. Each time the “vane” completes a rotation it actuates a magnetic reed switch. These signals from a water meter, fuel meter or any other type of flow meter can be counted in the form of interrupts which are totalized into time stamped hourly records and stored. These values can be compared to the minimum and maximum threshold values passed by the website 43 to set alarm flags.

As shown in FIG. 14, as the “vane” in the flow meter 450 rotates it actuates a reed switch which causes a ground signal to be applied to an RC network having resistors 402 and 401 on the pulse shaper 400, which is located on a mother board with the controller 30. The output of the RC network is buffered by hex inverters 404a, b. The hex inverters 404a, b cause an LED 403 to blink indicating a count has occurred. The controller 68 reads thru bit zero of Port E the low true logic level. Other types of flow meters can use a similar circuit.

In this embodiment the controller 68 sends serial data via Port C bit 2 to an RS 232 port (e.g., the converter/diagnostic port 76 of FIG. 3). The RS 232 converter is wired to a DB 9 connector located on the exterior of a cabinet thereby allowing a service technician to use a hyper-terminal, available on most standard laptop computers. The sent serial data contains the following information in a user-friendly format for each space 24a, b. In this embodiment, a horizontal row of characters contains the following information. The temperature in the space 24a, b, the pipe temperature 34a, the heat and cooling request ON states, the current heating and cooling limit values for specific spaces 24a, b and if permission for heating or cooling is currently being denied. Different types of diagnostic ports such as USB may be used in other embodiments.

The zone board can accept as an optional input, a signal from an optical device that can be used to detect the presence of a flame on a burner. This provides a means to measure and record the ON time of any fired boiler, water heater, dryer or any other device without disturbing any of the devices internal wiring or controls. This no touch feature insures that the system 20 will not interfere with or cause damage any boiler, chiller, water heater or dryer. In other embodiments other types of sensors may used.

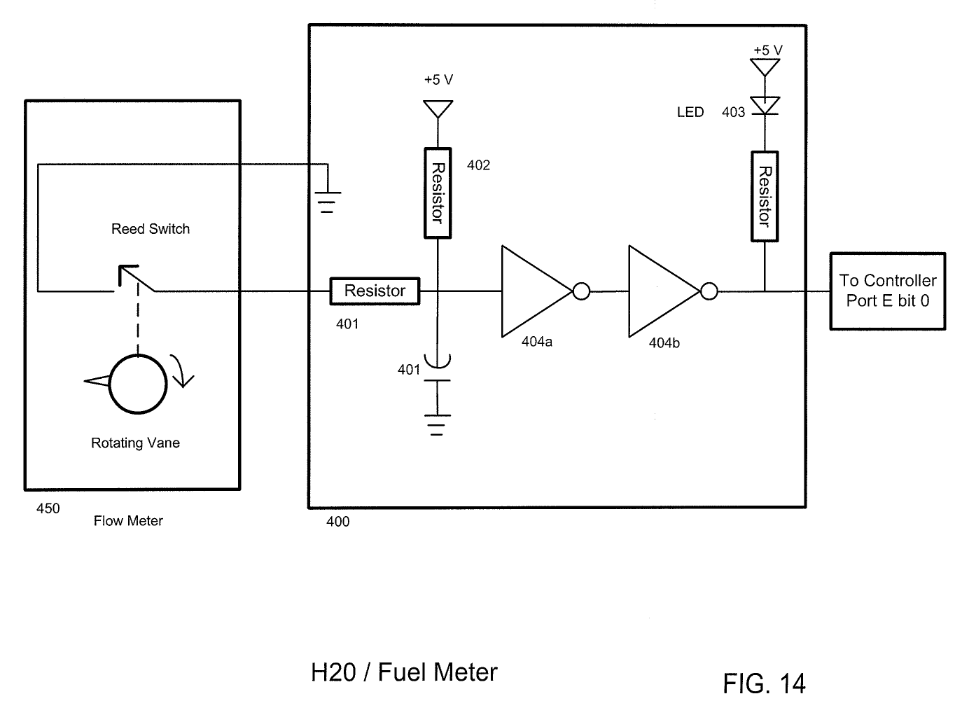

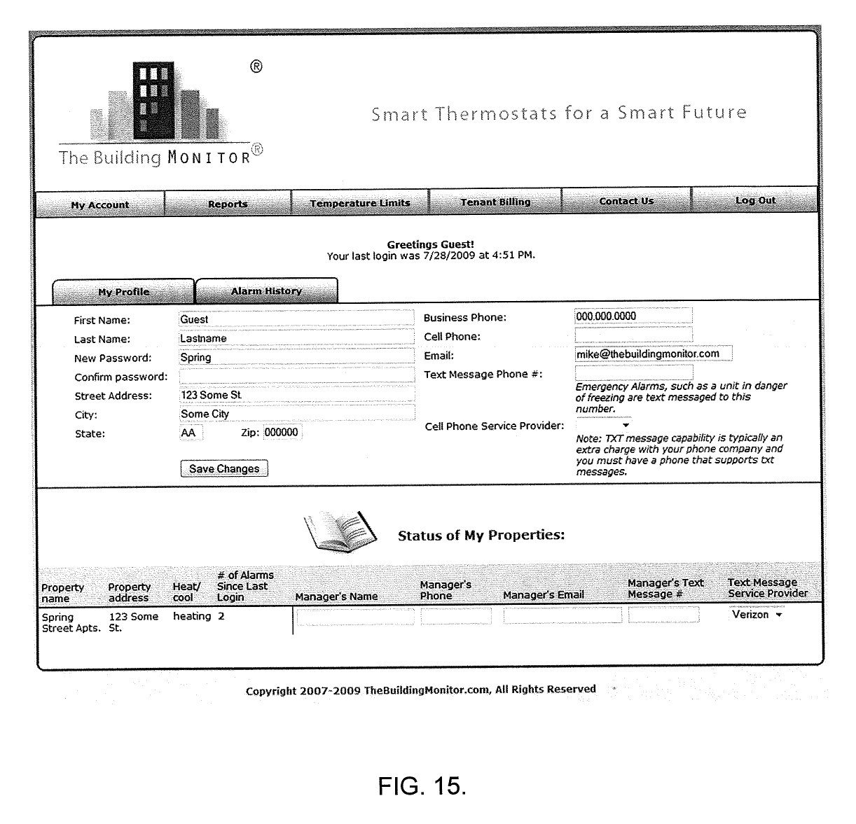

FIG. 15 is a screenshot of an example My Account Page that provides a simplistic and powerful overview of a clients account. A greeting component is adaptive and knows which user you are and knows the time and date of the user last logged in. This provides security and feedback to the user so they know that no unauthorized parties have accessed their account.

A Subcategory My Profile page provides personal information that can be customized by the account holder (user). The information the account holders can customize includes: first name; last name; new password; confirm password; street address; city; state; business phone; cell phone; email address; text message phone and cell phone service provider. An email option provides email notices and alarms in real time. This keeps owners apprised of what is going on in their properties so that they can operate them more efficiently.

The notices include but are not limited to:

a. Heat in unit (x) being left on while windows in unit (x) have been left open for extended period of time;

b. Zone valve complications: what the problem is, which valve it is and a suggested solution;

c. Zone pump complications: what the problem is, which pump it is and a suggested solution;

d. Tenant tampering: which unit is being tampered with, and what the nature of tampering is (examples of tenant tampering include a tenant trying to remove a thermostat or a tenant artificially cooling the thermostat, such as placing an ice pack on it); and

e. In danger of freezing alarm (with info regarding which specific unit or units are in danger).

An administrator can customize which alarms are text messaged to a users cell phone. This can be independently customized for each of the user's properties.

A Status of My Properties page provides an overview of all the user's properties. The Status of My Properties page includes but is not limited to Property Name, Property address, current mode of heating system, number of alarms since the users last login, (managers name, phone number, email address, cell phone number and cell phone provider). The user can set a separate manager for each of their properties. Each of the managers will also be emailed and text messaged alarms and notices.

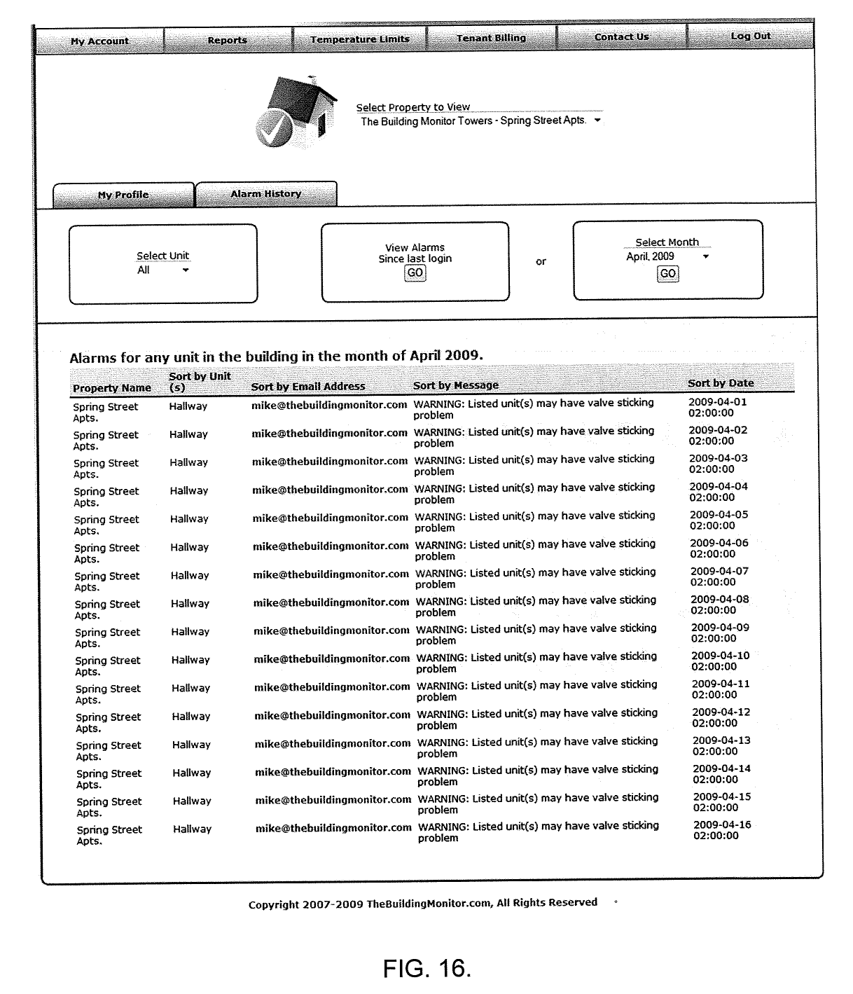

FIG. 16 shows a screenshot of an example Alarm History Page. The user can select which property to view. In one embodiment, the page defaults to the last property the user had selected. The Alarm History Page shows results to a user with as few mouse clicks as possible. For example, activation of a View Alarms Since Last Login Button knows when your last login was and automatically ties that to an alarm search on each of the user's properties. This allows the user to view the most relevant information quickly and easily with just one mouse click.

The user can perform history searches of alarms by selecting the month and clicking a “go” button. The user can do an even deeper analysis by combining the search types with the unit selector and selecting an individual unit to view. The unit selector defaults to “all” for user convenience. Once alarms are displayed, the user can easily sort the results by: unit #, email address alarms were sent to, type of message and date message was sent.

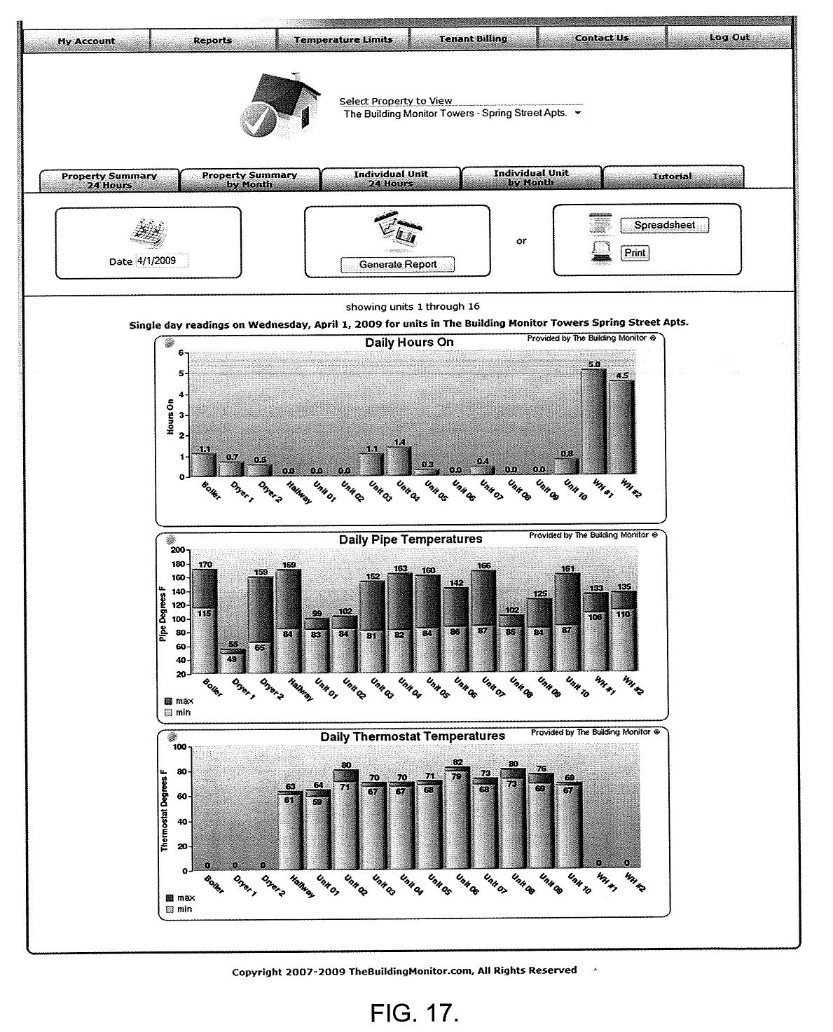

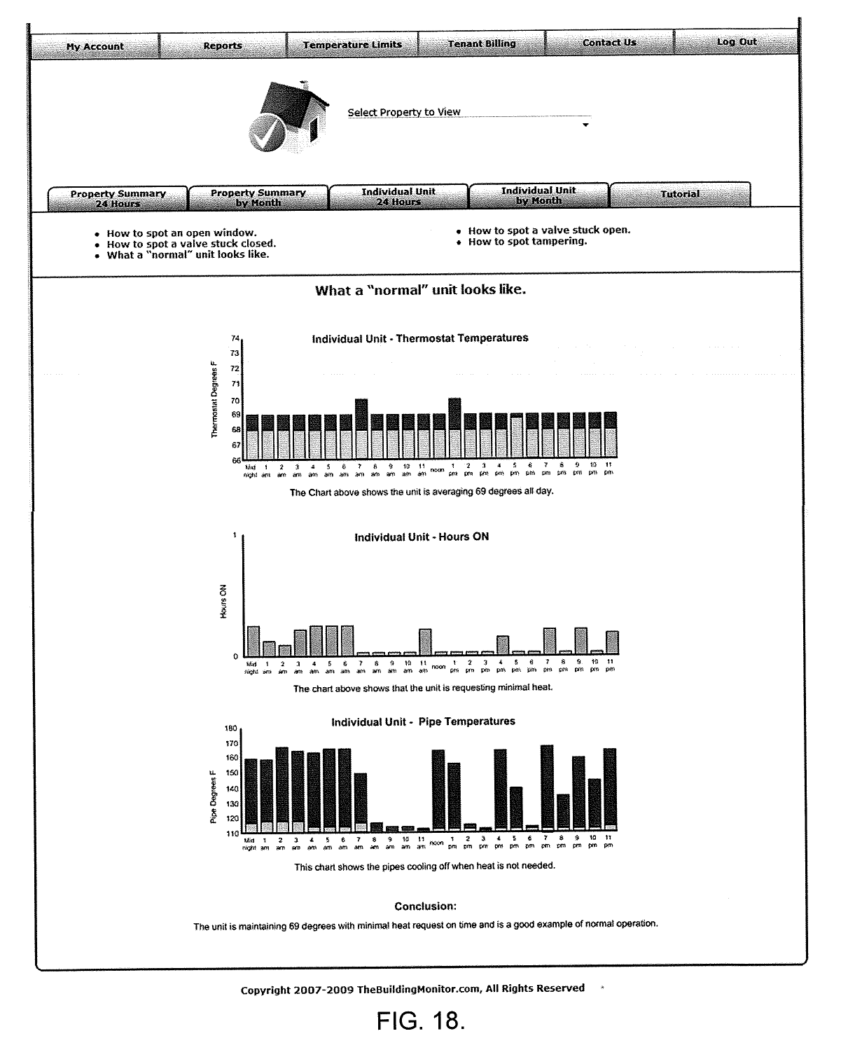

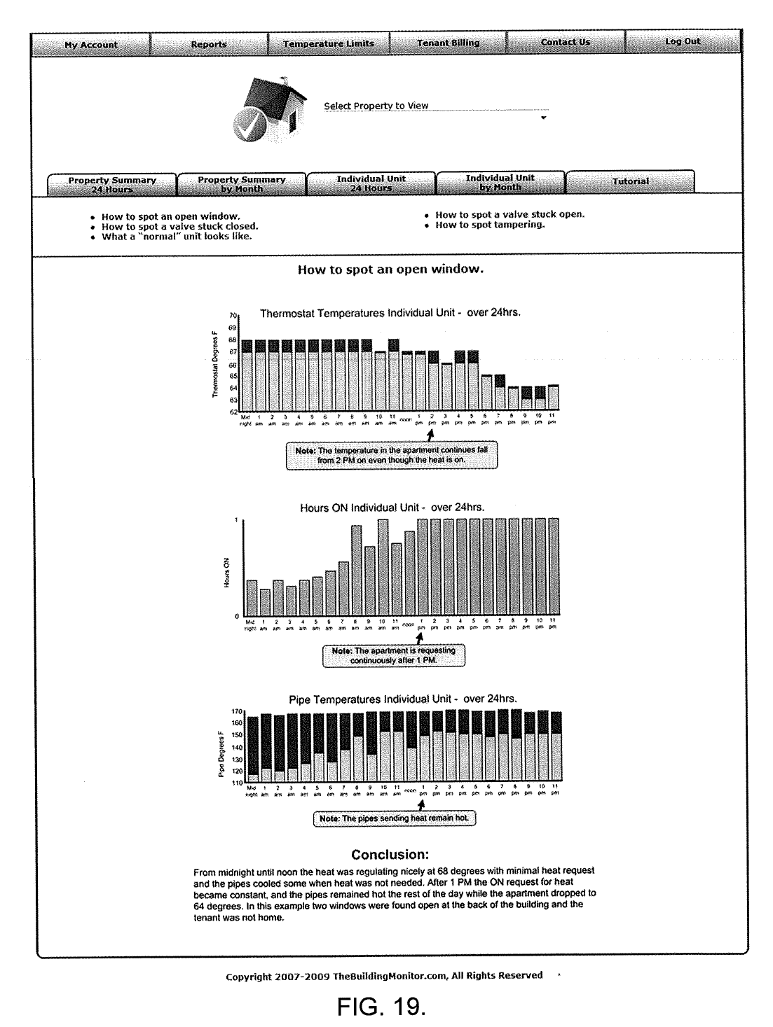

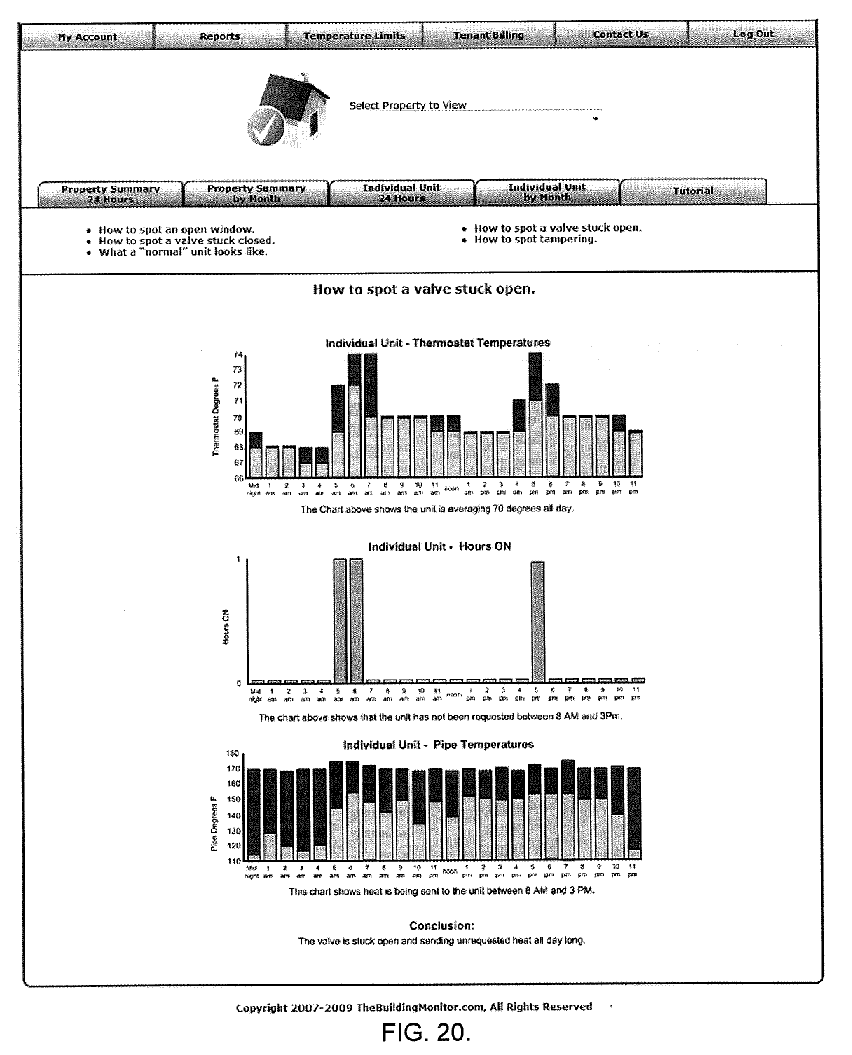

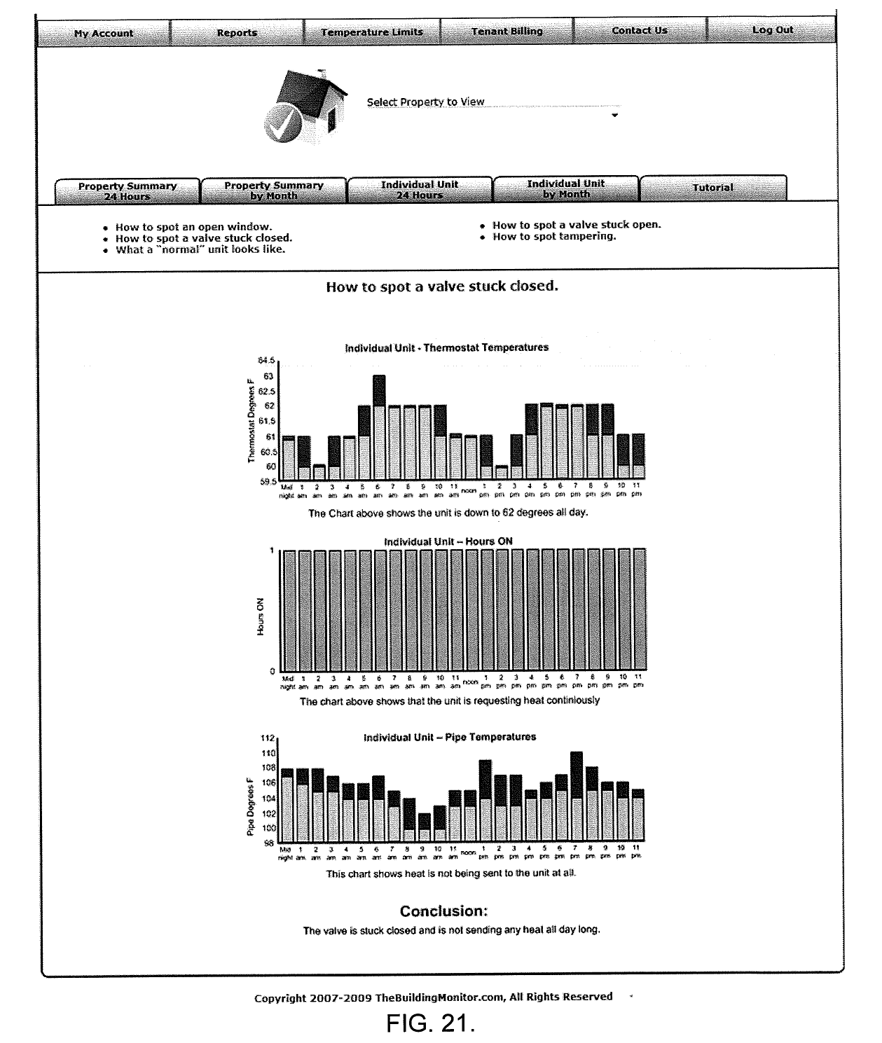

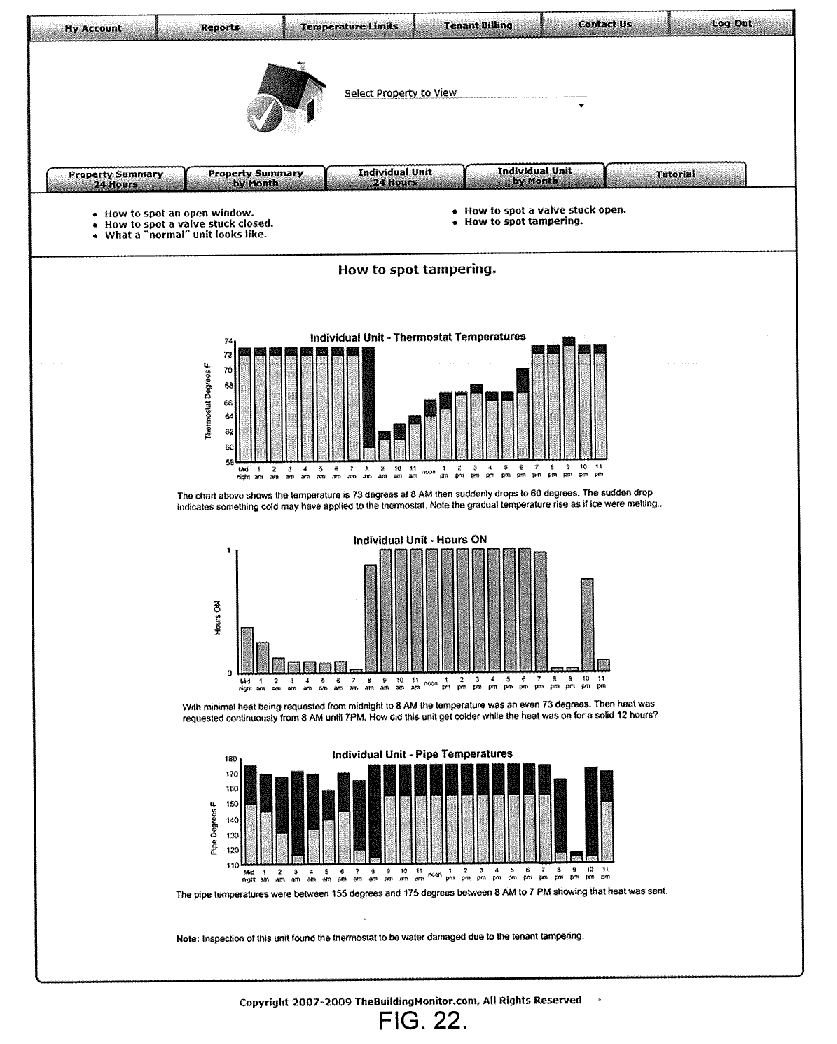

FIG. 17 shows a screenshot of an example Reports Page. In the Reports Page, the user can select which property to view. The Reports Page defaults to the last property the user had selected. A Property Summary 24 Hours subpage provides an overview of the user's property's heat consumption and temperature range over one day. A Property Summary by Month subpage provides an overview of the user's property's heat consumption and temperature range over a month or more. An Individual Unit 24 hrs subpage provides a zoomed in look at a user's heat consumption and temperature range for every hour of one day. A subcategory Individual Unit by month subpage provides a zoomed in look at a user's heat consumption and temperature range over a month or more. A Tutorial subpage FIGS. 18-23 teaches users how to use the charts and also how the system spots alarms such as open window. The charts that can be displayed show the tenants' request for heat, how the pipes in the boiler room heat up in response to the request, and the resulting temperature in the actual apartment.

All the subcategories show these charts shown. The top chart shows the number of hours each unit requested heat. The next chart shows the range of pipe temperatures. The bottom chart shows the temperature range inside every unit.

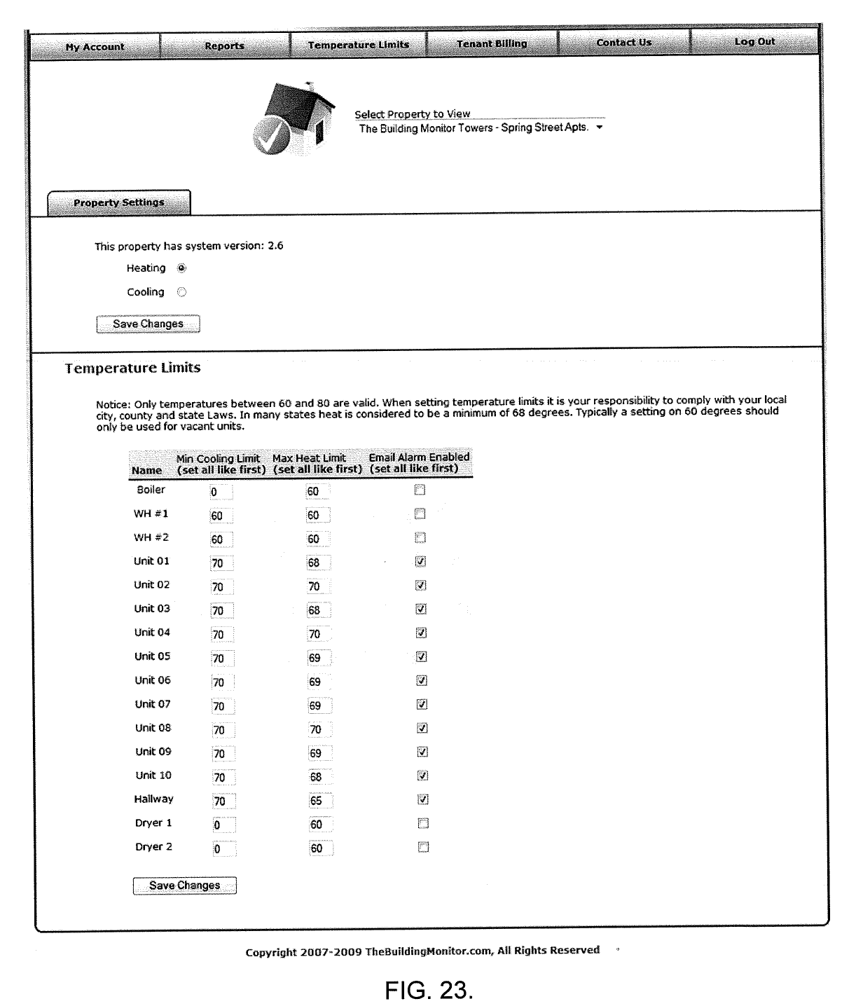

FIG. 23 shows a screenshot of an example Temperature Limits Page. In the Temperature Limits Page the user can select which property to view. The Temperature Limits Page defaults to the last property the user had selected. The Temperature Limits Page includes Property Settings for identifying the present electronic package that has been installed with each property and gives the user corresponding options based on what system they have. A Temperature Limits section displays a chart showing the configuration of the selected building. The chart includes channel name, minimum cooling limit maximum heating limit, and email alarm enable/disable for each channel. In this example, users can set both heating and cooling temperature limits between 60 and 80 degrees. Any changes made and saved one these pages are sent to the respective system 22 via the network 44. The tenants can still regulate their own heat/cooling via a programmable thermostat. However, the tenants are limited to the temperature settings that have been saved here.

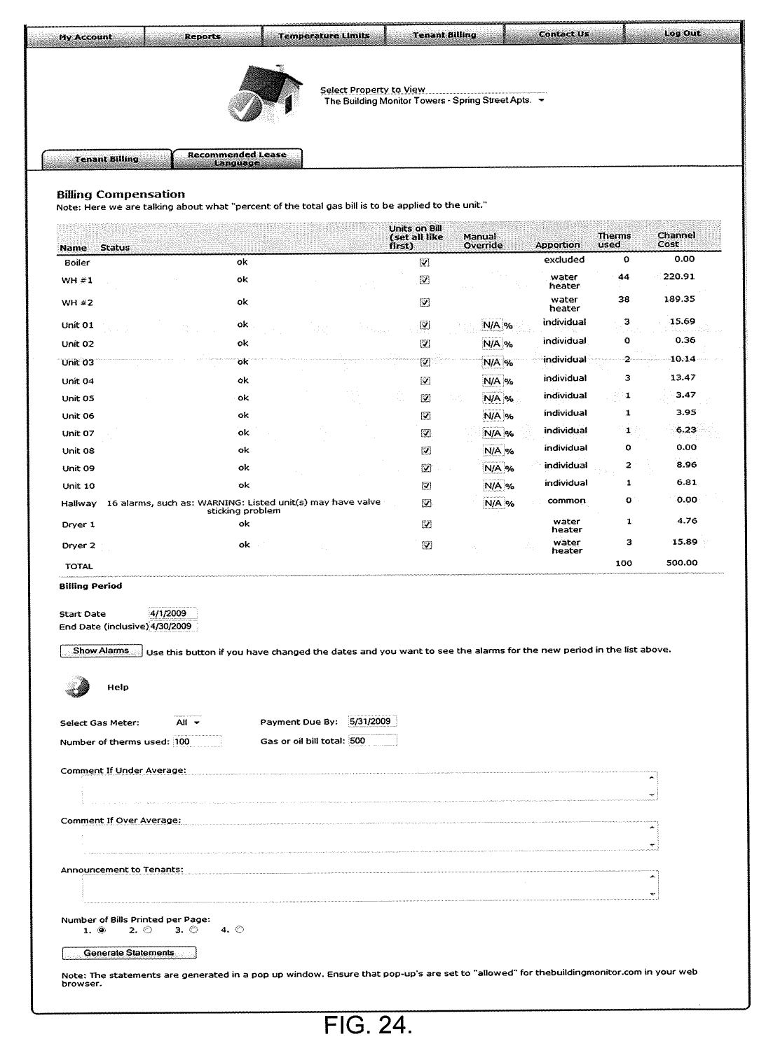

FIG. 24 shows a screenshot of an example Tenant Billing page that allows users to accurately and fairly bill their tenants based on recorded heat/cooling consumption information. Once a subject property has been selected, this page displays a billing compensation table that is populated with the configuration of the specific building, corresponding number of apartment units, common hallways, dryers, water heaters and boilers, etc. The user can select the start and end date to match the billing cycle of their gas bill. The user can select which gas meter(s) are placed on the bill. The user can fill in the corresponding number of therms consumed from the actual gas bill. The user can input total charge of the gas bill and when they would like to receive payments. The user can then update the billing compensation table with all the selected information by clicking the show alarms button. The table now displays the proportioned amounts of each apartment units heat/cooling consumption. These calculations are based on the actual number of seconds each unit asked for and received heat which is reported as is stored by the respective system 22. To ensure the integrity of billing, the page reports any recorded alarms and faults detected during the date rage to be billed. If faults are detected users can manually override the apportioned amount to be billed to ensure that a tenant is not being billed unfairly. The user can write custom comments/message to tenants on the bill for the following conditions:

a. tenants who are under the average energy consumption;

b. tenants who are over the average energy consumption; and

c. general announcement to all tenants.

The user can then select the number of bills to be printed per page and then click the generate statements button which opens up a pop up window in the web browser that shows the tenants' bills ready to be printed.

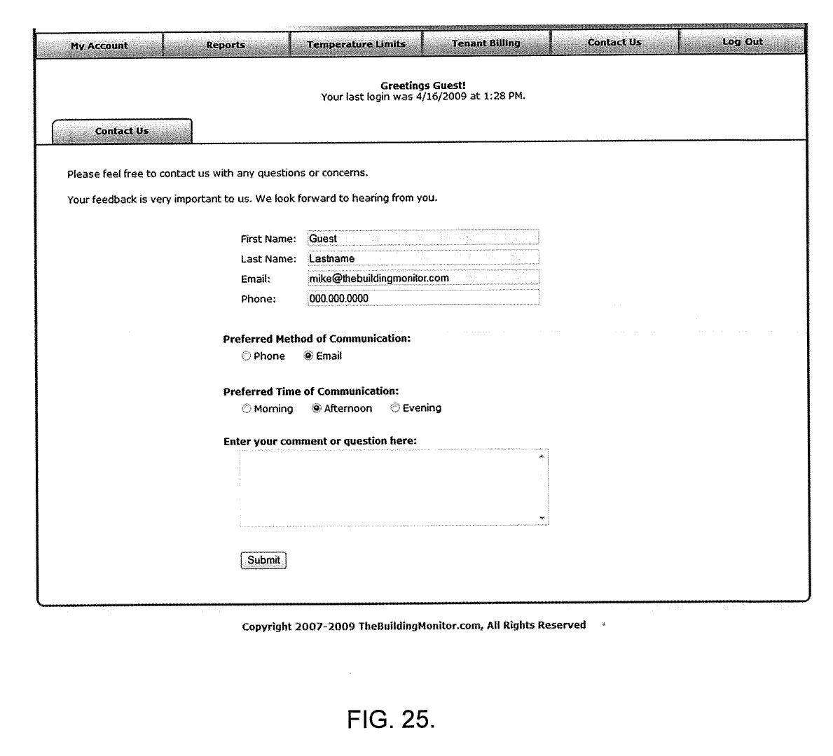

FIG. 25 shows a screenshot of an example Contact Us Page that includes a greeting that is adaptive and knows which user which user is logged in and knows the time and date from when the user last logged in. This page greets the user by their first name and allows the user to easily contact a customer support center. For convenience to the user this page is populated with the users first name, last name, email address and phone number that is saved in their “my account” page. The user can select preferred method and time of communication. The user can submit comments and or questions.

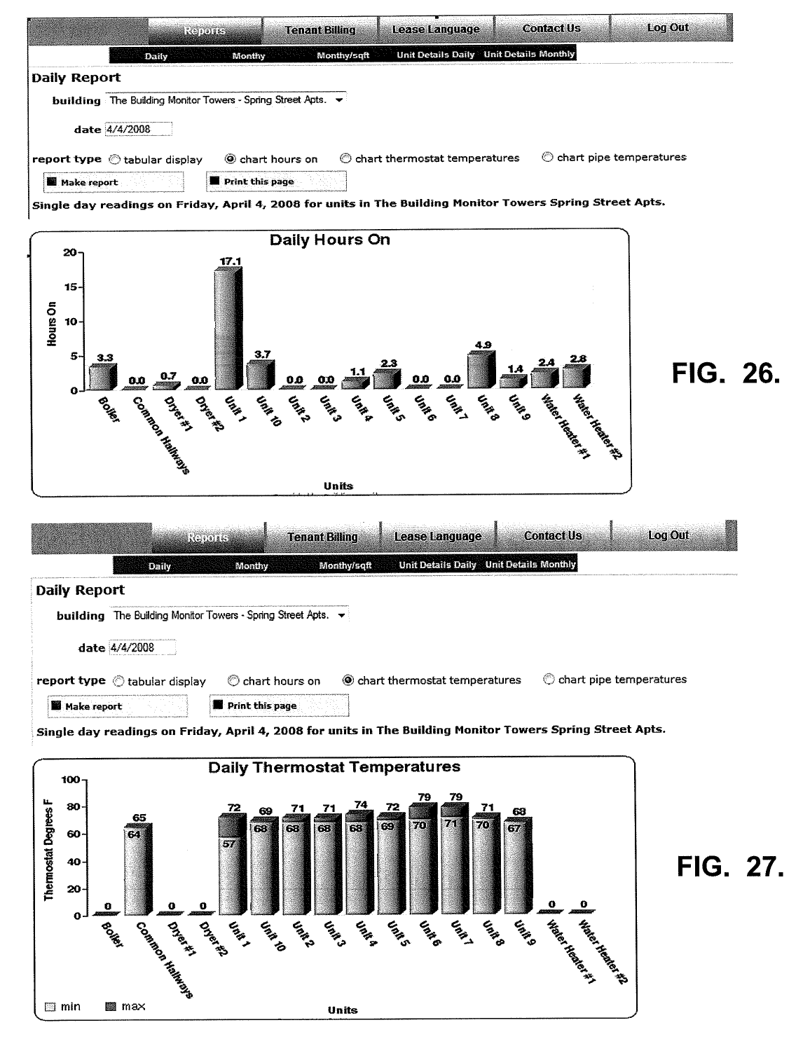

The example graph shown in FIG. 26 provides a daily total of on time for all units for a selected day. This gives a busy manager/owner a snapshot of how the property energy consumption is doing that day. Also any problems stand out. Such as unit 1 stands out as the consumption is many times greater than the other units.

FIG. 27 is an example graph showing the recorded high and low temperature of all units.

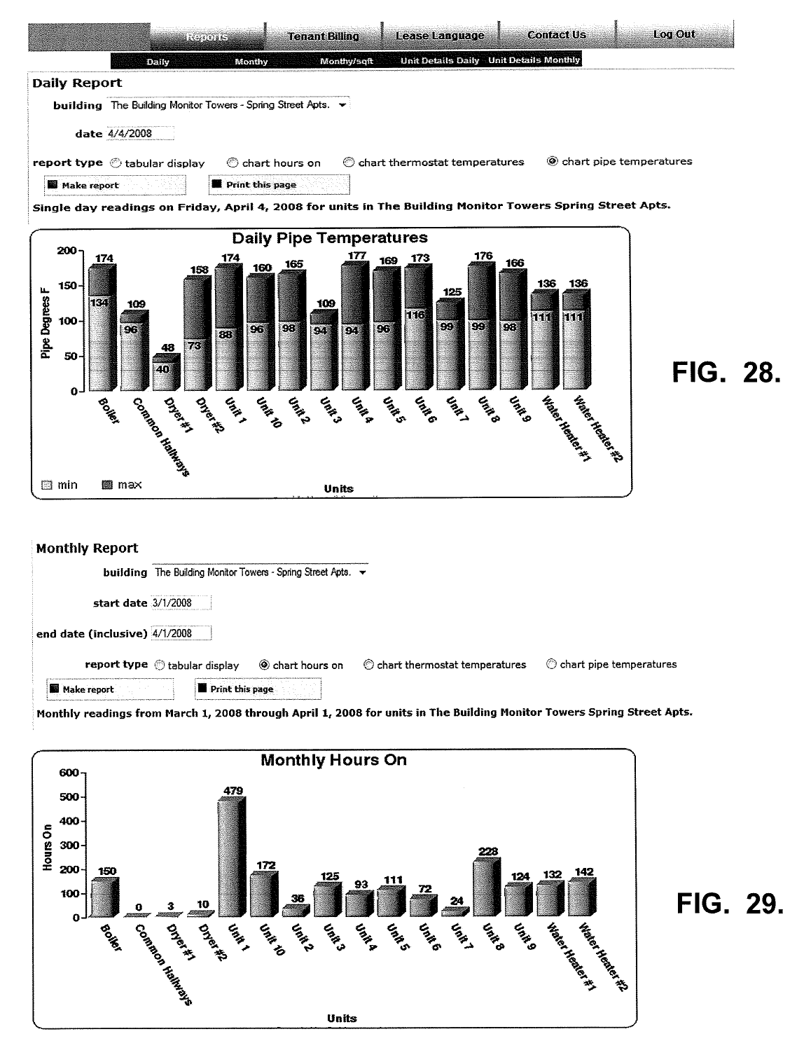

FIG. 28 is an example graph showing a summary for the selected day of the recorded high and low pipe temperatures.

FIG. 29 is an example graph showing the total on time for a selected date range for all units, dryers, boiler and water heaters.

FIG. 30 is an example graph showing the recorded high and low temperatures of all units included common areas like hallways, for a selected date range.

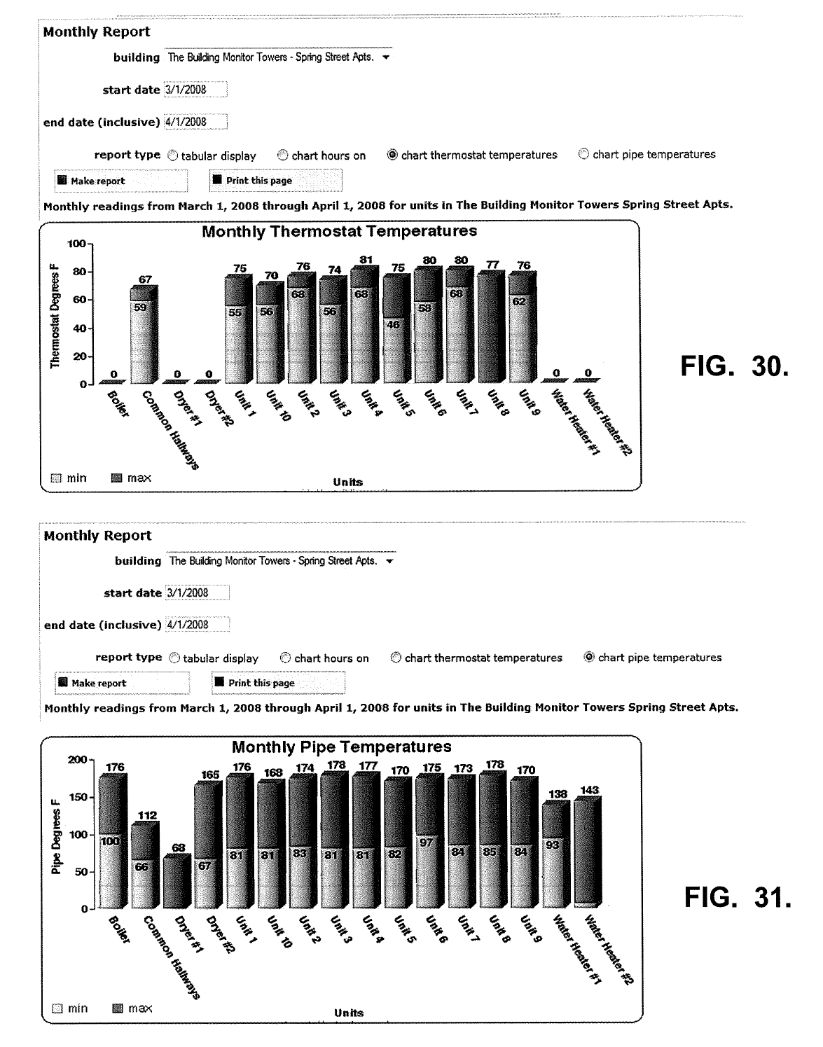

FIG. 31 is an example graph showing the recorded high and low pipe temperatures at the input side of all units included common areas like hallways, for a selected date range.

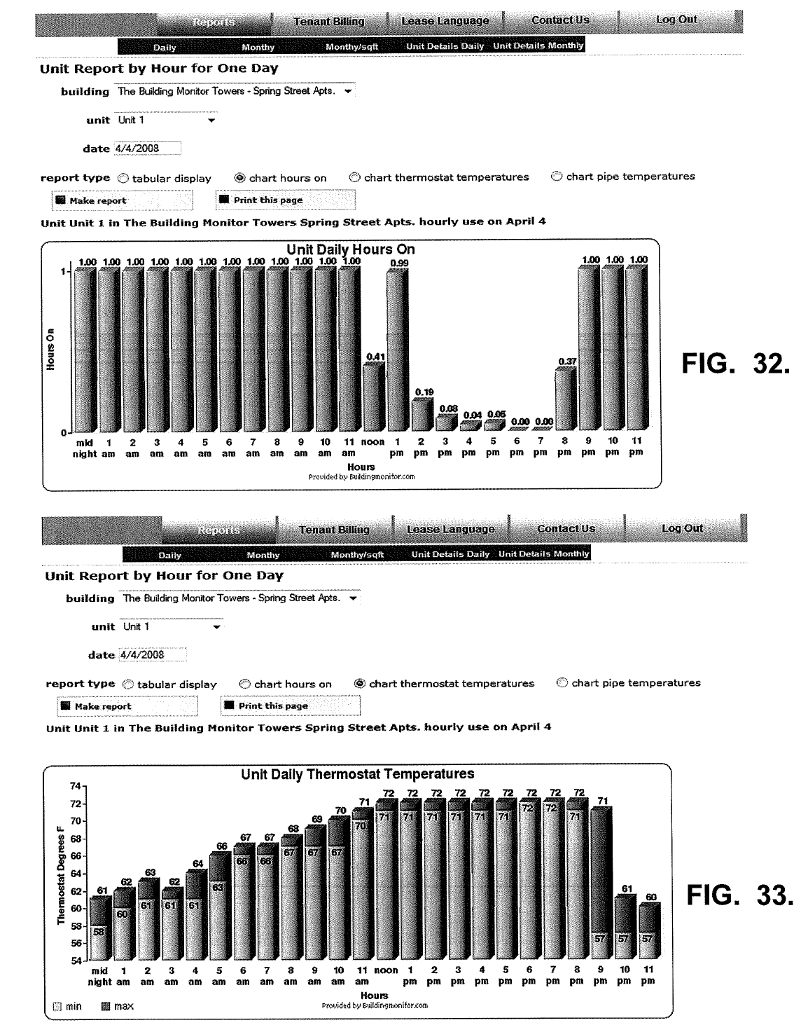

FIG. 32 is an example graph showing the ability to zoom in on a specific unit and examine the hourly recorded on time for a selected day.

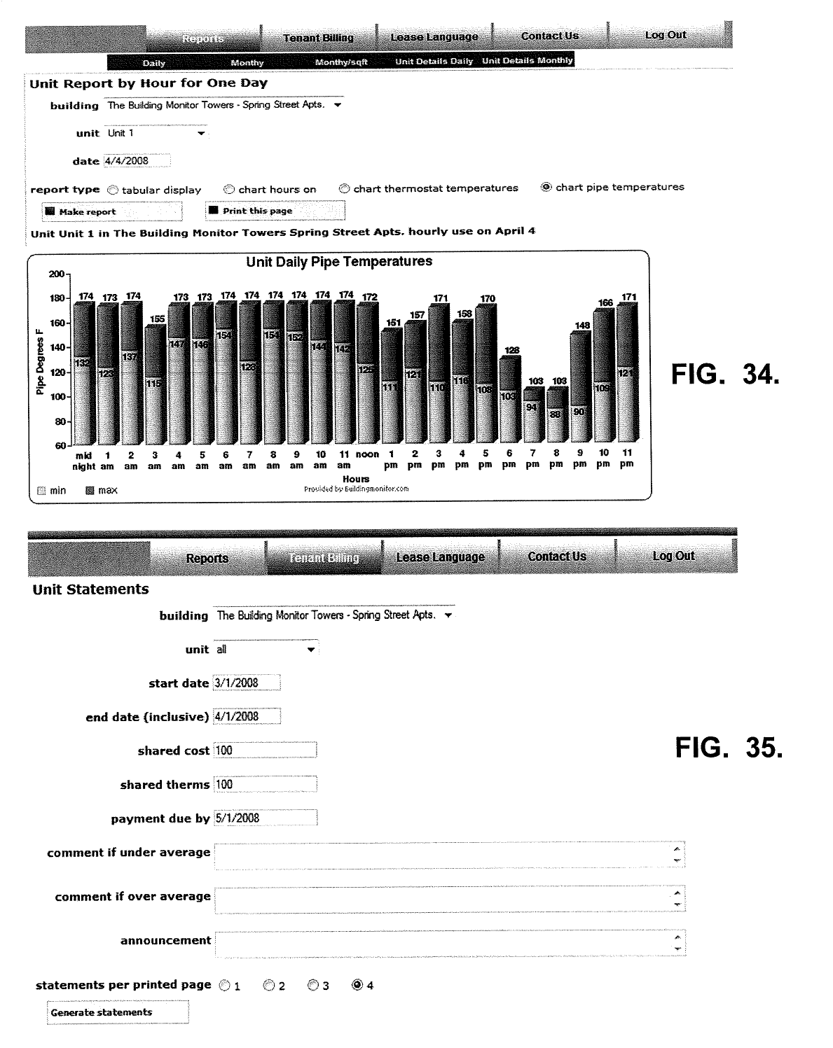

FIG. 33 is an example graph showing the ability to zoom in on a specific unit and examine the hourly recorded temperatures for a selected day.

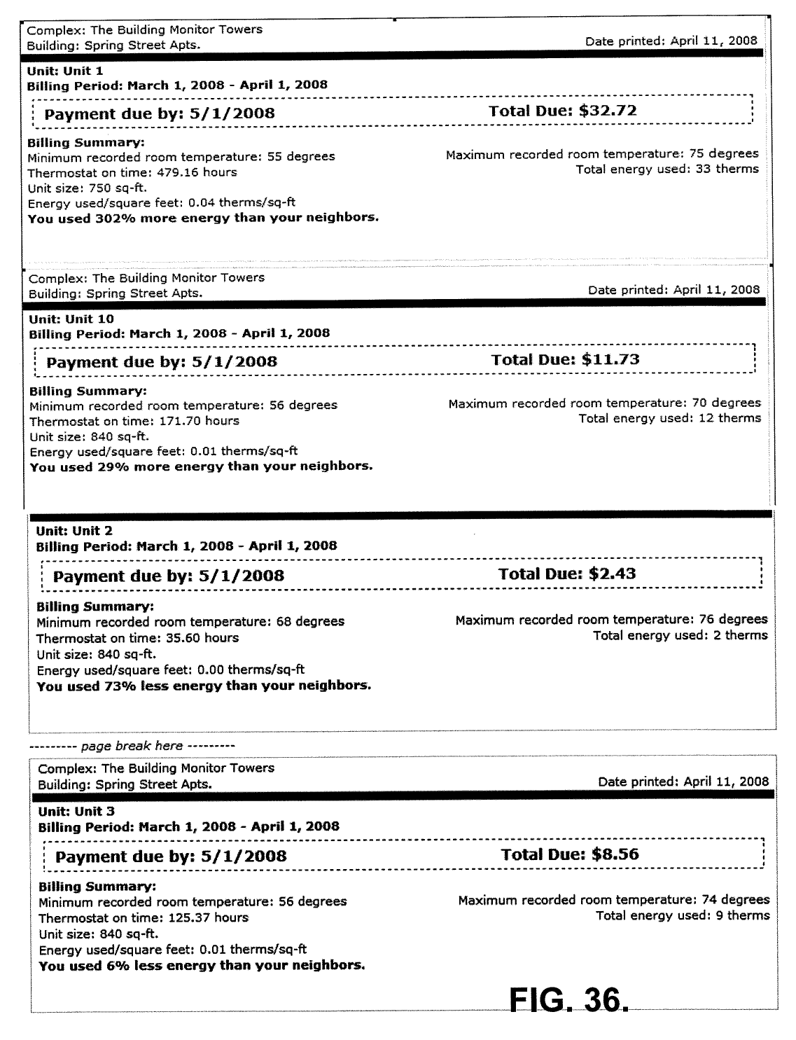

FIG. 34 is an example graph showing the ability to zoom in on a specific unit and examine the hourly recorded pipe temperatures on the supply side for a selected day.

FIG. 35 shows an example screenshot of a user interface that allows bill generation by the property manager. Start and stop dates are selected to match the billing period. The cost of the gas and the number of therms used are entered in separate fields. Water heater and gas dryer consumption is subtracted off of the gas bill so that the tenants are only billed for their heat usage. By entering $100 for the gas bill field, the individual gas bills generated become a percent of the total bill. This allows the manager to spot a problem with a short date range like a week.

FIG. 36 shows an example screenshot of a printable bill.

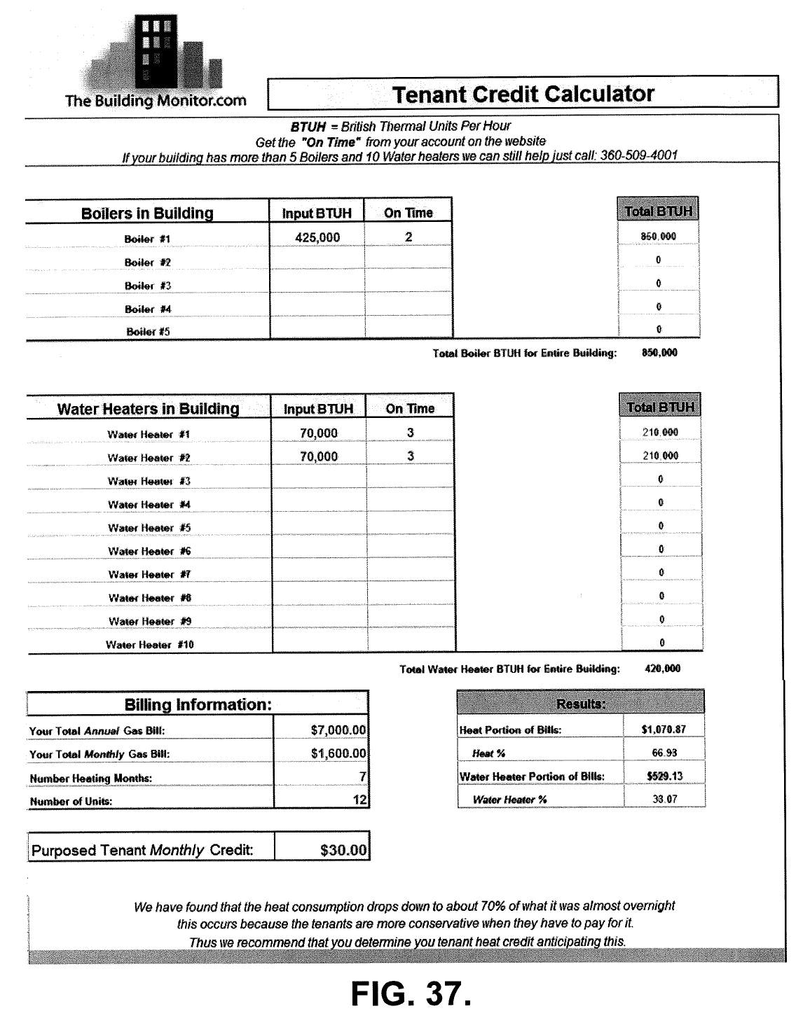

FIG. 37 shows an example screenshot of a user interface that allows the property owner or manager to help determine how much of a credit to give each tenant. The intention here is to initially pass some responsibility for the gas bill to the tenants. If they have to pay for their consumption beyond the credit amount the tenant will be more careful about their utility consumption.

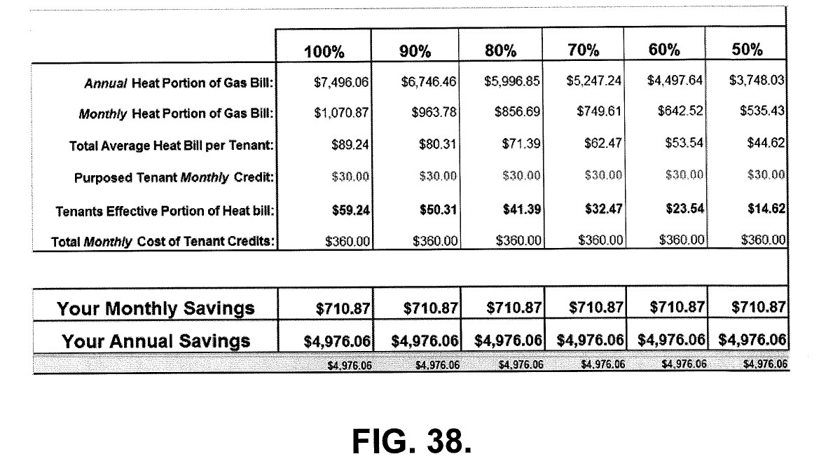

FIG. 38 is an example screenshot of a chart that shows the percentage reduction in gas bill from implementing this invention as compared to not. Once this system is installed problems like zone valves stuck open and delivering un-requested heat can be resolved. The max temperature setting for all units can be implemented. In this example many units were found to be heating to almost 80 degrees. Based on this it is possible to see a 30% reduction in gas consumption as shown in the above columns before billing any tenants. This chart is dynamic, in that the user can input boiler, water heater, billing information, and the tenant credit desired. The underlying application program then automatically calculates the results in the percentage column to help the owner evaluate the effect of the tenant credit to be selected.

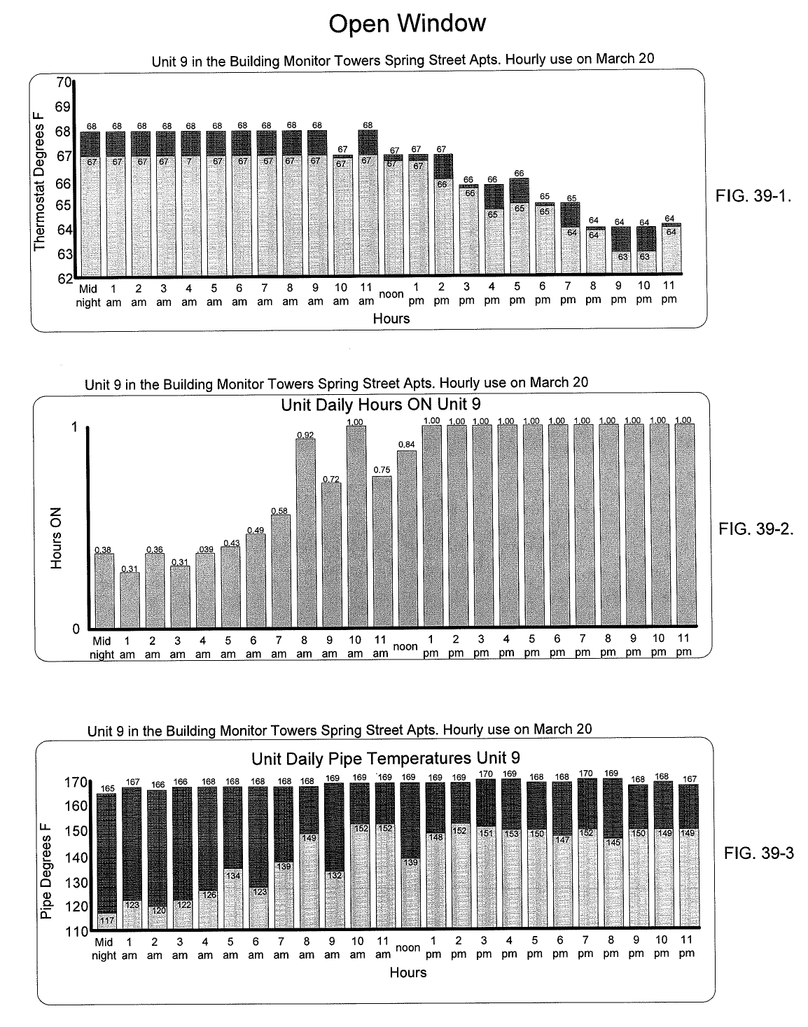

FIG. 39 shows an example Open Window condition. FIG. 39-1 is an example chart showing temperature falling from 2 pm even though the heat is on. FIG. 39-2 is an example chart showing the heat on continuously after 1 PM. FIG. 39-3 is an example chart showing that the pipes sending heat to unit 9 remain hot after 1 PM. From midnight until noon the heat was regulating nicely at 68 with minimal heat request and the pipes show some cooling when heat was not needed. After 1 PM the ON time request for heat became constant, and the pipes remained above 148 degrees the rest of the day but the apartment dropped to 64 degree. In this case two windows were found open on the back of the building and the tenant was not home.

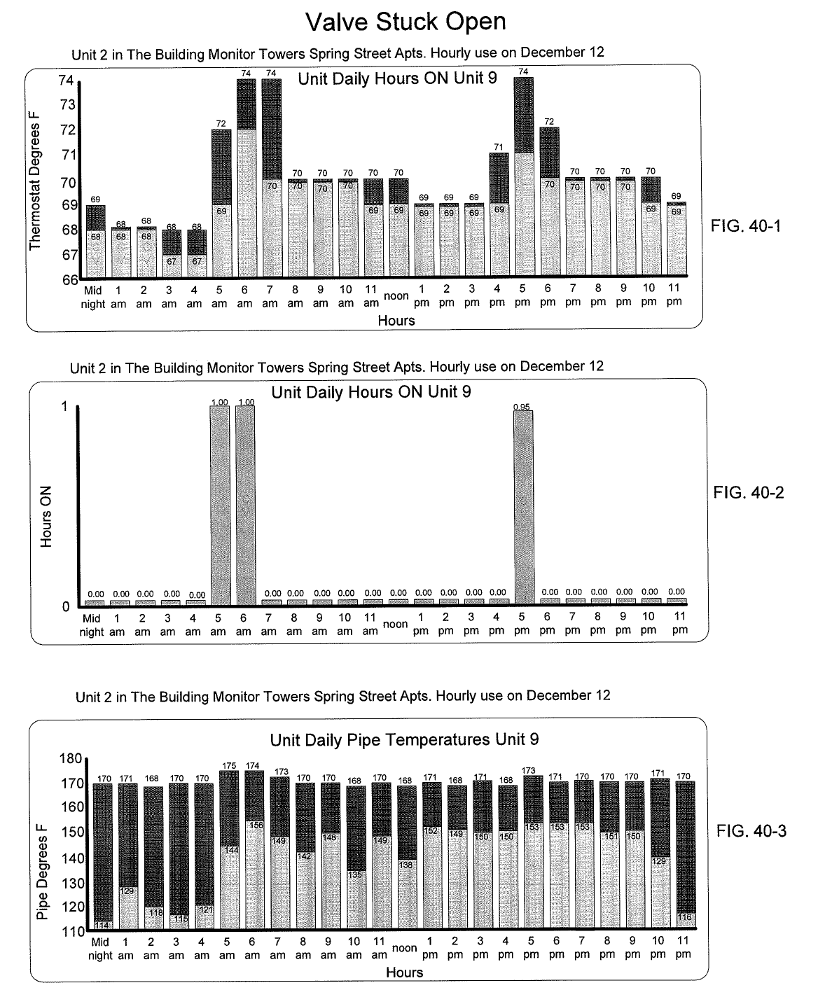

FIG. 40 shows an example Valve Stuck Open condition. FIG. 40-1 is an example chart showing that unit 2 is averaging around 70 degrees. FIG. 40-2 is a chart showing that unit 2 has not requested heat between 8 AM and 3 PM. FIG. 40-3 is a chart showing that heat is being sent to unit 2 between 8 AM and 3 PM even though heat was not requested according to the “daily hours on graph.” The conclusion is that a valve is stuck partially open, thereby sending heat all day long.

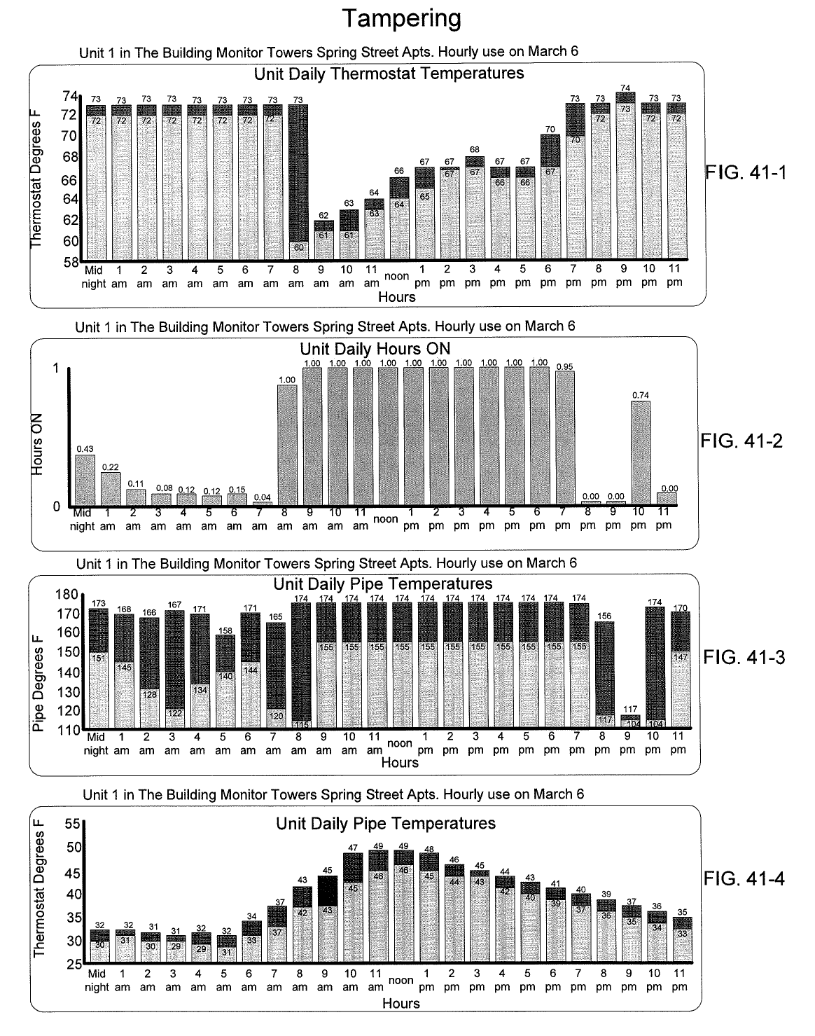

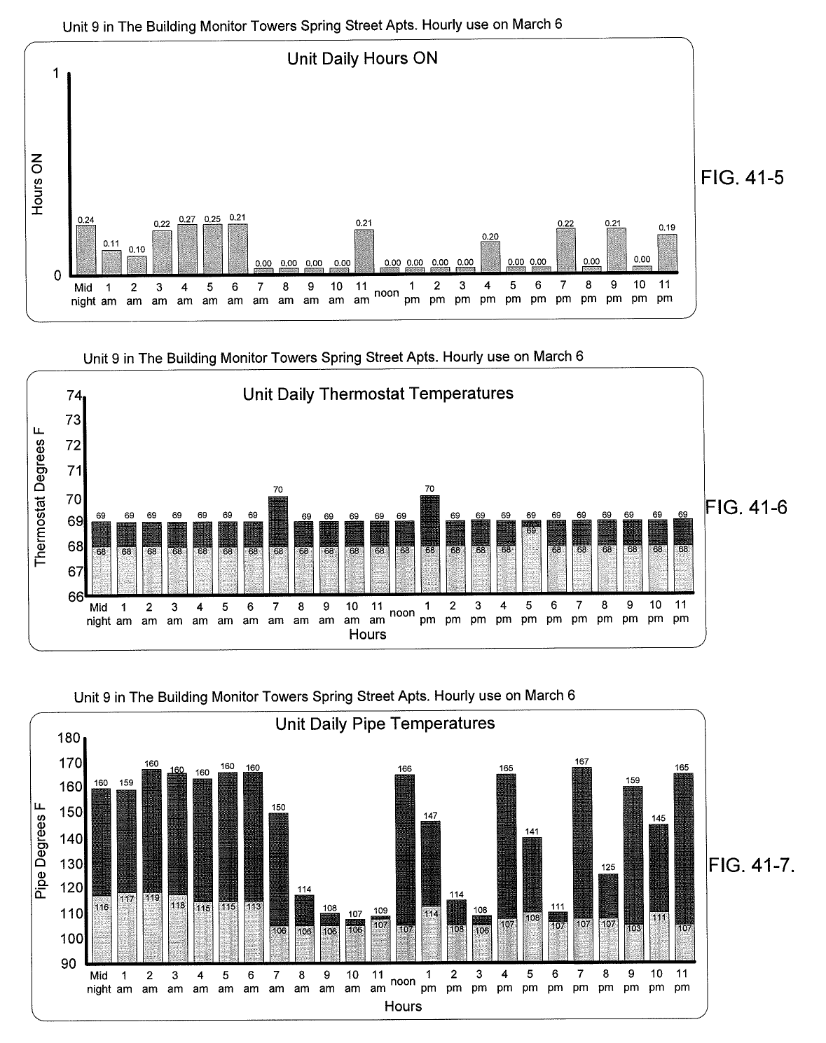

FIG. 41 shows an example Tampering condition. FIG. 41-1 is a chart showing the temperature is 73 degrees at 8 AM then suddenly drops to 60 degrees. The sudden drop indicates tampering by placing something cold on the thermostat. Then as the cold item warms up, the temperature rises on a slope over the next 12 hours. FIG. 41-2 is a graph that shows the heat request ON time for every hour of the day. Note that the thermostat is requesting heat continuously from 8 AM to 7 PM. With very little on time from midnight to 8 AM the temperature in unit 1 was an even 73 degrees. One has to ask how the unit got colder when more heat was delivered after 8 AM.

FIG. 41-3 is a graph showing that the pipe temperature in the boiler room is between 155 and 175 degrees at the same time. Inspection of this unit found the thermostat to be water damaged from tenant trying to cheat the system. FIG. 41-4 shows the temperature from an outside temperature probe. In summary, the audit trail proves that the tenant in unit 1 was tampering with the thermostat. The temperature inside unit 1 dropped 13 degrees in less than an hour while the heat was on continuously and the outside air temperature was rising to almost 50 degrees.

The graphs in FIGS. 41-5 thru 41-7 show what a normal apartment looks like during the same day. FIG. 41-7 shows the boiler room piping for unit 9 cools down as the unit doesn't request heat during the warm part of the day.

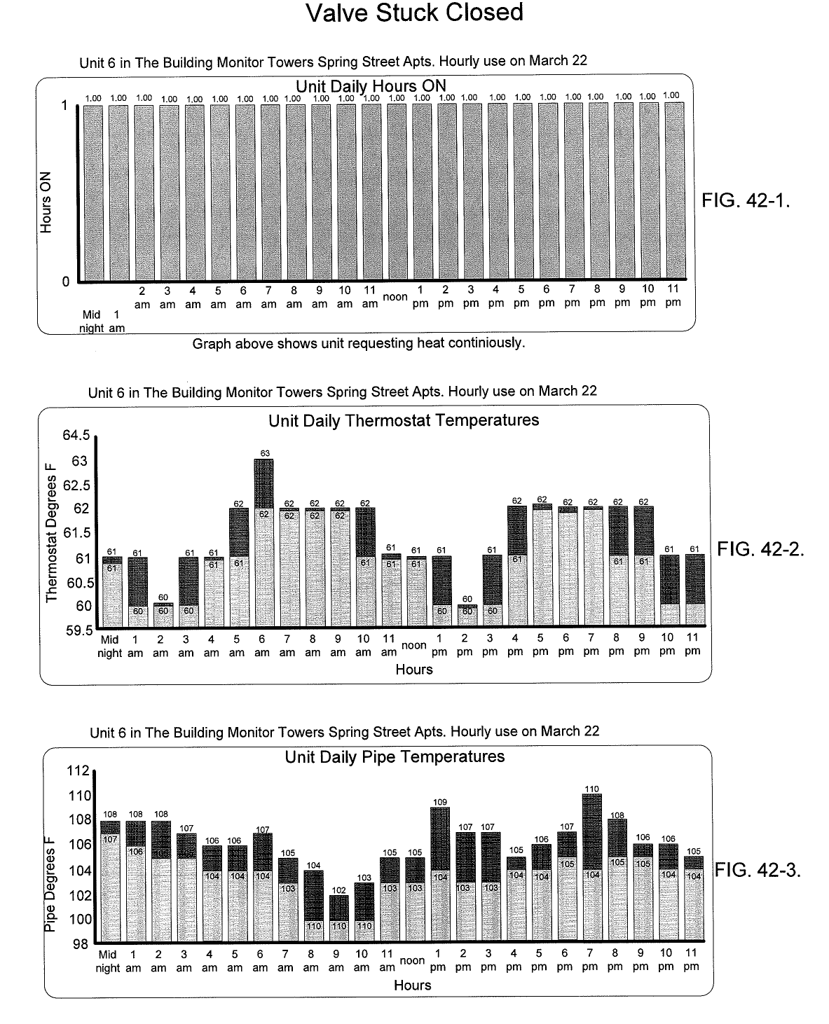

FIG. 42 shows a Valve Stuck Closed condition. FIG. 42-1 is a graph showing a unit is requesting heat continuously. FIG. 42-2 is a graph showing the unit is down to 62 all day even though they are requesting heat. FIG. 42-3 is a graph showing the pipes are not sending heat. Normal pipe temperatures compared to working units are 155 to 175 degrees.

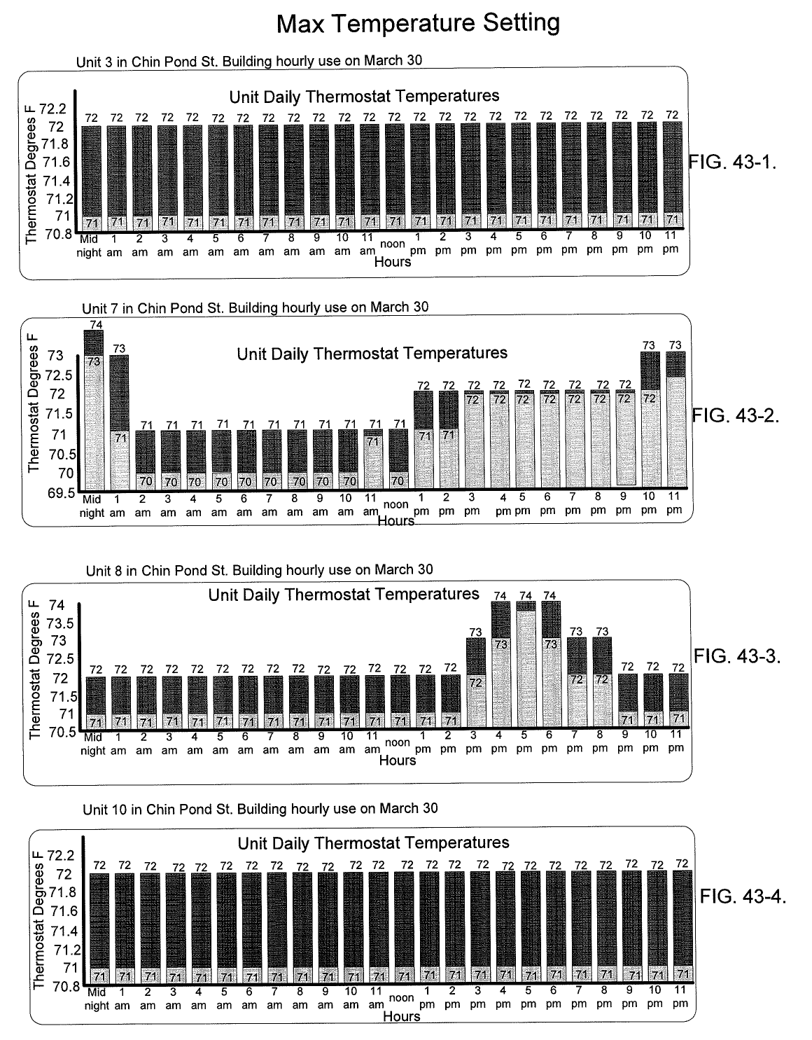

FIG. 43 shows a Max temperature setting condition. FIG. 43-1 is a graph showing that this unit is being heated to 72 degrees “the max temperature limit” all day. FIG. 43-3 shows that this tenant used an electric heater between 3 PM and 8 PM to get 74 degrees.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A system for controlling one or more utilities for a plurality of units, the system comprising:
a first component located at each of the units, the first component comprising:
a thermostat configured to generate a utility request signal;
a temperature sensor configured to generate an analog temperature signal; and
a circuit coupled to the thermostat and the temperature sensor, the circuit configured to digitize the analog temperature signal;
a plurality of pipe temperature sensors configured to sense temperature of pipes that supply one of the one or more utilities to the units;
a second component configured to:
receive the sensed pipe temperature from the plurality of pipe temperature sensors;
receive the digitized temperature signal from the first component via a first electrical connection;
receive the utility request signal from the first component; and
output a utility valve control signal based on the received relative sensed pipe temperature, digitized temperature signal, and utility request signal.

2. The system of claim 1, wherein the second component is further configured to determine if the utility event satisfies a predefined alert condition and output a message if the utility event is determined to satisfy the predefined alert condition.

3. The system of claim 2, wherein the predefined alert condition includes a tampering condition.

4. The system of claim 2, wherein the predefined alert condition includes a valve stuck closed condition.

5. The system of claim 2, wherein the predefined alert condition includes a valve stuck open condition.

6. The system of claim 2, wherein the predefined alert condition includes a open window condition.

7. The system of claim 1, wherein the second component is further configured to generate a user interface accessible by other devices over a network, wherein the user interface comprises a graph configured to present utility requested information based on the utility request signal, a graph configured to present actual unit temperature information based on the received temperature signal, and a graph configured to present pipe temperature information based on the received pipe temperatures.

8. The system of claim 7, wherein the utility requested information graph comprises accumulated time the utility was requested.

9. The system of claim 7, wherein the actual unit temperature information graph comprises high and low temperature values for each hour of each day.

10. The system of claim 7, wherein the pipe temperature information graph comprises high and low temperature values for each hour of each day.
